(19) United States
(12) Patent Application Publication
(10) Pub. No.: US 2026/0004241 A1
(43) Pub. Date: Jan. 1, 2026

(54) Computer-Implemented Method and Apparatus, and Computer Program Product

(71) Applicants: Beijing BOE Technology Development Co., Ltd., Beijing (CN); BOE Technology Group Co., Ltd., Beijing (CN)

(72) Inventor: Jinxiao WEN, Beijing (CN)

(21) Appl. No.: 18/992,201

(22) PCT Filed: Nov. 16, 2023
(86) PCT No.: PCT/CN2023/132089

§ 371 Date: Jan. 8, 2025

(30) Foreign Application Priority Data
Dec. 26, 2022 (WO) PCT/CN2022/141880
Jun. 29, 2023 (CN) 202310789914.X

(51) Int. Cl. G06Q 10/087; G06Q 10/04; G06Q 10/0875

(52) U.S. Cl. CPC G06Q 10/0877; G06Q 10/04; G06Q 10/0875

(57) ABSTRACT

A computer-implemented method and apparatus, and a computer program product. The computer-implemented method comprises: by means of a first input interface, receiving a material query instruction inputted by a user; in response to the material query instruction, acquiring, from a data source, data of a plurality of materials for manufacturing one or more product components, wherein the data of the plurality of materials comprises the available inventory of the plurality of materials; calculating the maximum consumption of the plurality of materials with respect to at least one of the one or more product components; and according to the maximum consumption of the corresponding materials of the plurality of materials and the available inventory of the corresponding materials of the plurality of materials, determining whether the amount of one or more materials for manufacturing the one or more product components is insufficient.

### CROSS-REFERENCE TO RELATED APPLICATIONS

The present application is a U.S. National Phase Entry of International Application No. PCT/CN2023/132089 having an international filing date of Nov. 16, 2023, which claims priorities to PCT International Application No. PCT/CN2022/141880 filed on Dec. 26, 2022 and entitled “Computer-Implemented Method, Apparatus for Managing Production of One or More Products, and Computer Program Product”, and Chinese Patent Application No. 202310789914.X filed on Jun. 29, 2023 and entitled “Computer-Implemented Method, Apparatus, and Computer Program Product”, contents of the above-mentioned PCT international application and Chinese patent application should be construed as being incorporated herein by reference.

### TECHNICAL FIELD

Embodiments of the present disclosure relate to, but are not limited to, the field of display technologies, and in particular to a computer-implemented method, an apparatus, and a computer program product.

### BACKGROUND

Management of product production is a complex process, and in a case that a large number of products and starting materials are involved, material management becomes more difficult when the demand for products and engineering of a manufacturing process change rapidly in a short time. Traditional material management or simple programming is not enough to manage production, and it is difficult to manage materials, often resulting in material shortage, overstock, and waste.

### SUMMARY

The following is a summary of subject matters described herein in detail. The summary is not intended to limit the protection scope of claims.

In a first aspect, an embodiment of the present disclosure also provides a computer-implemented method, including; receiving a material query instruction input by a user through a first input interface; in response to the material query instruction, acquiring, from a data source, data of a plurality of materials for manufacturing one or more product components, wherein the data of the plurality of materials includes available inventory amounts of the plurality of materials; calculating maximum consumption amounts of the plurality of materials with respect to at least one of the one or more product components; and determining whether there is shortage in one or more materials for manufacturing the one or more product components according to a maximum consumption amount of a corresponding material of the plurality of materials and an available inventory amount of the corresponding material of the plurality of materials.

In an exemplary implementation mode, the method further includes: determining whether there is a next-level material for a material with shortage when it is determined that there is shortage in the plurality of materials for manufacturing the one or more product components; acquiring data of a plurality of next-level materials of one or more materials with shortage for manufacturing the one or more product components when it is determined that there is the next-level material for the material with shortage, the data of the plurality of next-level materials of the one or more materials with shortage includes available inventory amounts of the plurality of next-level materials; calculating maximum consumption amounts of the plurality of next-level materials with respect to at least one of the one or more materials with shortage; determining whether there is shortage in the plurality of next-level materials according to a maximum consumption amount and an available inventory amount of a corresponding material of the plurality of next-level materials.

In an exemplary implementation mode, the data of the plurality of materials includes information on substitution relationships among the plurality of materials, and the data of the plurality of next-level materials further includes information on substitution relationships among the next-level materials; before acquiring the data of the plurality of next-level materials of the one or more materials with shortage for manufacturing the one or more product components, further including: discriminating one or more materials with shortage in a second group from the one or more materials with shortage according to the information on the substitution relationships among the plurality of materials; wherein the one or more materials with shortage in the second group are non-substitutable materials with respect to at least one of the one or more product components; before calculating the maximum consumption amounts of the plurality of next-level materials with respect to at least one of the one or more materials with shortage, further including: discriminating, data of one or more next-level materials in a third group and data of one or more next-level materials in a fourth group from data of the one or more materials with shortage in the second group according to the information on the substitution relationships among the next-level materials, wherein the one or more next-level materials in the third group are substitutable materials with respect to at least one of the one or more materials with shortage in the second group, and the one or more next-level materials in the fourth group are non-substitutable materials with respect to at least one of the one or more materials with shortage in the second group.

In an exemplary implementation mode, the calculating maximum consumption amounts of the plurality of materials with respect to at least one of the one or more product components includes: calculating a maximum consumption amount of one or more materials in the second group with respect to the one or more product components according to data of the one or more materials in the second group; the determining whether there is shortage in one or more materials for manufacturing the one or more product components according to the maximum consumption amount of the corresponding material of the plurality of materials and the available inventory amount of the corresponding material of the plurality of materials includes: calculating a remaining amount of the one or more materials in the second group according to an available inventory amount of the one or more materials in the second group and a maximum consumption amount of the one or more materials in the second group, and determining whether there is shortage in the one or more materials in the second group according to the remaining amount of the one or more materials in the second group.

In an exemplary implementation mode, the calculating the maximum consumption amount of the one or more materials in the second group with respect to the one or more product components according to data of the one or more materials in the second group includes: using a sum of, a demanded amount for one or more product components requiring one or more materials in the second group as non-substitutable materials multiplied by values of corresponding unit consumption of corresponding materials in the second group with respect to manufacturing the one or more product components, respectively, to obtain the maximum consumption amount of the one or more materials in the second group with respect to the one or more product components.

In an exemplary implementation mode, when it is determined that there is shortage in one or more materials in the second group, further including: calculating a shortage amount of the one or more materials with shortage in the second group according to the available inventory amount of the one or more materials with shortage in the second group and the maximum consumption amount of the one or more materials with shortage in the second group.

In an exemplary implementation mode, the calculating the maximum consumption amounts of the plurality of next-level materials with respect to at least one of the one or more materials with shortage includes: calculating a maximum consumption amount of one or more next-level materials in the fourth group with respect to one or more materials with shortage in the second group; the determining whether there is shortage in the plurality of next-level materials according to the maximum consumption amount and the available inventory amount of the corresponding material of the plurality of next-level materials includes: using an available inventory amount of one or more next-level materials in the fourth group to subtract a maximum consumption amount of the one or more next-level materials in the fourth group to obtain a remaining amount of the one or more next-level materials in the fourth group, and determining whether there is shortage in the one or more next-level materials in the fourth group according to the remaining amount of the one or more next-level materials in the fourth group.

In an exemplary implementation mode, the calculating the maximum consumption amount of one or more next-level materials in the fourth group with respect to one or more materials with shortage in the second group includes: using a sum of, a shortage amount of one or more materials with shortage in the second group requiring one or more next-level materials in the fourth group as non-substitutable materials multiplied by values of unit consumption of corresponding next-level materials in the fourth group for manufacturing one or more corresponding materials with shortage in the second group respectively, to obtain the maximum consumption amount of the one or more next-level materials in the fourth group with respect to the one or more materials with shortage in the second group.

In an exemplary implementation mode, the method further includes: when it is determined that there is shortage in one or more next-level materials in the fourth group, obtaining a shortage amount of the one or more next-level materials in the fourth group according to the remaining amount of the one or more next-level materials in the fourth group, and displaying a shortage amount and a shortage state of the one or more next-level materials in the fourth group through a first output interface; when it is determined that there is no shortage in the one or more next-level materials in the fourth group and the remaining amount is 0, displaying the remaining amount and a material state of the one or more next-level materials in the fourth group through the first output interface; when it is determined that there is no shortage in the one or more next-level materials in the fourth group and the remaining amount is greater than 0, according to the information on the substitution relationships among the next-level materials, determining whether the one or more next-level materials in the fourth group are substitutable materials with respect to at least one of one or more materials with shortage in the first group; when it is determined that the one or more next-level materials in the fourth group are not substitutable materials with respect to the one or more materials with shortage in the first group, determining that there is overstock in the one or more next-level materials in the fourth group, and displaying an overstock state and the remaining amount of the one or more next-level materials in the fourth group through the first output interface.

In an exemplary implementation mode, the calculating the maximum consumption amounts of the plurality of next-level materials with respect to at least one of the one or more materials with shortage includes: calculating a maximum consumption amount of one or more semi-finished components in a third group with respect to one or more materials with shortage in a second group using a third linear programming model; the determining whether there is shortage in the plurality of next-level materials according to the maximum consumption amount and the available inventory amount of the corresponding material of the plurality of next-level materials includes: using an available inventory amount of one or more next-level materials in the third group to subtract a maximum consumption amount of the one or more next-level materials in the third group to obtain a remaining amount of the one or more next-level materials in the third group, and determining whether there is shortage in the one or more next-level materials in the third group according to the remaining amount of the one or more next-level materials in the third group.

In an exemplary implementation mode, the method further includes: when it is determined that there is shortage in the one or more next-level materials in the third group, obtaining a shortage amount of the one or more next-level materials in the third group according to the remaining amount of the one or more next-level materials in the third group, and displaying the shortage amount and a shortage state of the one or more next-level materials in the third group through a first output interface; when it is determined that there is no shortage in the one or more next-level materials in the third group and the remaining amount is 0, displaying the remaining amount and a material state of the one or more next-level materials in the third group through the first output interface; when it is determined that there is no shortage in the one or more next-level materials in the third group and the remaining amount is greater than 0, according to the information on the substitution relationships among the next-level materials, determining whether the one or more next-level materials in the third group are substitutable materials with respect to at least one of one or more materials with shortage in the first group; when it is determined that one or more materials in the third group are not substitutable materials with respect to the one or more materials with shortage in the first group, determining that there is overstock in the one or more next-level materials in the third group, and displaying an overstock state and the remaining amount of the one or more next-level materials in the third group through the first output interface.

In an exemplary implementation mode, a third objective function of the third linear programming model is expressed as follows.

$$obj 3 = max {\sum }_{i = 1}^{N} {d}_{i} * {x}_{i} .$$

Herein, xᵢ represents a satisfiable amount of a corresponding next-level material in the third group for preparation of a corresponding material with shortage in the second group; dᵢ represents a value of unit consumption of a corresponding next-level material in the third group with respect to one or more corresponding materials with shortage in the second group; N is a positive integer, N≥1.

In an exemplary implementation mode, the third objective function is constrained by a first constraint function, and the first constraint function is expressed as follows.

$${\sum }_{{x}_{i} ∈ ( {Q}_{l} , {G}_{j} )} {x}_{i} \leq {Q}_{l} .$$

Herein, Qₗ represents a shortage amount of an l-th material with shortage in the second group; (Qₗ, Gⱼ) represents a set of variables (which may be a collection of variables) of a j-th group of next-level materials with respect to the l-th material with shortage, and a plurality of next-level materials in the j-th group are substitutable for each other when producing the l-th material with shortage; 0≤xᵢ≤Qₗ; 1≤j≤J, wherein J represents a total number of groups of next-level materials that are substitutable for each other when producing the l-th material with shortage.

In an exemplary implementation mode, the third objective function is constrained by a second constraint function, and the second constraint function is expressed as follows.

$${\sum }_{{x}_{i} ∈ {X}_{m}} {d}_{i} * {x}_{i} \leq {C}_{m} .$$

Herein, Cₘ represents an available inventory amount of an m-th type of next-level material in the third group; Xₘ represents a set of variables (which may be a collection of variables) of an m-th next-level material; 1≤m≤M, wherein M represents a total number of types of next-level materials in the third group.

In an exemplary implementation mode, the data of the plurality of materials includes information on substitution relationships among the plurality of materials and a demanded amount for one or more product components; before acquiring the data of the plurality of next-level materials of the one or more materials with shortage for manufacturing the one or more product components, further including: discriminating one or more materials in a first group from the plurality of materials according to the information on the substitution relationships among the plurality of materials, wherein the one or more materials in the first group are substitutable materials with respect to at least one of the one or more product components; the calculating the maximum consumption amounts of the plurality of materials with respect to at least one of the one or more product components includes: calculating a maximum consumption amount of the one or more materials in the first group with respect to the one or more product components according to data of the one or more materials in the first group; the determining whether there is shortage in one or more materials for manufacturing the one or more product components according to the maximum consumption amount of the corresponding material of the plurality of materials and the available inventory amount of the corresponding material of the plurality of materials includes: acquiring a satisfiable amount of one or more substitutable material groups in the first group with respect to the one or more product components when a consumption amount of one or more materials in the first group with respect to the one or more product components is a maximum consumption amount, and determining whether there is shortage in the one or more substitutable material groups in the first group with respect to a corresponding product component according to the satisfiable amount of the one or more substitutable material groups in the first group with respect to the one or more product components and a demanded amount for the one or more product components.

In an exemplary implementation mode, the determining whether there is the next-level material for the material with shortage when it is determined that there is shortage in the plurality of materials for manufacturing the one or more product components includes: determining whether there is a next-level material for a material group with shortage in the first group when it is determined that there is shortage in one or more substitutable material groups in the first group with respect to the corresponding product component; the acquiring data of the plurality of next-level materials of one or more materials with shortage for manufacturing the one or more product components when it is determined that there is the next-level material for the material with shortage includes: acquiring material data of one or more next-level materials of one or more material groups with shortage in the first group when it is determined that there is a next-level material for a material group with shortage in the first group; the calculating the maximum consumption amounts of the plurality of next-level materials with respect to at least one of the one or more materials with shortage includes: taking a plurality of next-level materials of one or more material groups with shortage in the first group as one or more next-level materials in a fifth group, calculating a maximum consumption amount of one or more next-level materials in the fifth group with respect to a product component corresponding to one or more material groups with shortage in the first group according to material data of the one or more next-level materials in the fifth group; the determining whether there is shortage in the plurality of next-level materials according to the maximum consumption amount and the available inventory amount of the corresponding material of the plurality of next-level materials includes: calculating a remaining amount of one or more next-level materials in the fifth group according to an available inventory amount of one or more next-level materials in the fifth group and a maximum consumption amount of one or more next-level materials in the fifth group with respect to the product component corresponding to one or more corresponding material groups with shortage in the first group, and determining whether there is shortage in the one or more next-level materials in the fifth group according to the remaining amount of the one or more next-level materials in the fifth group.

In an exemplary implementation mode, when it is determined that there is shortage in one or more substitutable material groups in the first group with respect to the corresponding product component, further including: calculating a shortage amount of one or more substitutable material groups in the first group with respect to the corresponding product component according to a satisfiable amount of one or more substitutable material groups in the first group with respect to the corresponding product component and a demanded amount of a material with shortage in the first group; when it is determined that there is shortage in one or more next-level materials in the fifth group, further including: calculating a sixth shortage value according to a satisfiable amount of one or more next-level materials in the fifth group for preparation of a corresponding material with shortage in the first group and a shortage amount of a corresponding material group with shortage in the first group, and updating the shortage amount of the corresponding material group with shortage in the first group with the sixth shortage value; acquiring a configuration parameter, reallocating a shortage amount of a material with shortage in the corresponding material group with shortage in the first group according to the configuration parameter, updating a shortage amount of a corresponding material in the first group with an allocated shortage amount, and displaying the shortage amount and a shortage state of the corresponding material in the first group through a first output interface.

In an exemplary implementation mode, the method further includes: when it is determined that there is shortage in one or more next-level materials in the fifth group, acquiring a shortage amount of the one or more next-level materials in the fifth group according to the remaining amount of the one or more next-level materials in the fifth group, and displaying the shortage amount and a shortage state of the one or more next-level materials in the fifth group through a first output interface; when it is determined that there is no shortage in the one or more next-level materials in the fifth group and the remaining amount is greater than 0, outputting the remaining amount and an overstock state of the one or more next-level materials in the fifth group through a first display interface; when it is determined that there is no shortage in the one or more next-level materials in the fifth group and the remaining amount is equal to 0, outputting the remaining amount and a material state of the one or more next-level materials in the fifth group through the first display interface.

In an exemplary implementation mode, the method further includes: when it is determined that there is shortage in the one or more next-level materials in the fifth group, acquiring a configuration parameter of a next-level material, reallocating a shortage amount of a material with shortage in a corresponding next-level material group with shortage in the fifth group according to the configuration parameter of the next-level material, updating a shortage amount of a corresponding next-level material in the fifth group with a reallocated shortage amount, and displaying an updated shortage amount and a shortage state of the corresponding next-level material in the fifth group through the first output interface.

In an exemplary implementation mode, the method further includes: when it is determined that there is shortage in the one or more next-level materials in the fifth group, acquiring a configuration parameter of a next-level material, reallocating a shortage amount of a corresponding next-level material with shortage in the fifth group according to the configuration parameter of the next-level material, and updating the shortage amount of the corresponding next-level material in the fifth group with a reallocated shortage amount.

In an exemplary implementation mode, the method further includes: displaying a shortage state of a material with shortage through a first output interface when it is determined that there is no next-level material for the material with shortage; when it is determined that there is no shortage in one or more materials for manufacturing one or more product components, displaying material information of the one or more materials for manufacturing the one or more product components through the first output interface.

In an exemplary implementation mode, the method further includes: adjusting a demand for the one or more product components to minimize overstock or shortage in the next-level materials when it is determined that there is overstock or shortage in the one or more materials with shortage according to the maximum consumption amount and the available inventory amount of the corresponding material of the plurality of next-level materials; and producing the one or more product components based on an adjusted demand for the one or more product components.

In an exemplary implementation mode, the method further includes: generating one or more user interfaces.

Herein, the one or more user interfaces include a first output interface, and the first output interface is further configured to display a material state of a corresponding material in at least one of a first group to a fifth group.

In an exemplary implementation mode, the one or more user interfaces further include the first input interface configured to receive one or more user inputs for querying a database; wherein the data of the plurality of materials is stored in the database.

Herein, the computer-implemented method further includes: receiving, from the first input interface, user selection of one or more conditions, wherein the user selection is for selecting a material state associated with the one or more conditions; and in response to the user selection, querying the database to determine one or more material states in the database associated with the one or more conditions; the one or more conditions include at least one of an overstock state of an overstocked material and a shortage state of a material with shortage; the one or more user interfaces further include a second output interface configured to display one or more overstocked materials or materials with shortage as a result of querying the database.

In an exemplary implementation mode, the one or more user interfaces further include a second input interface configured to receive one or more user inputs for adjusting a priority of a corresponding material in the first group; wherein the computer-implemented method further includes: re-determining whether the corresponding material in the first group is overstocked or short based on an adjusted priority of the corresponding material in the first group.

In an exemplary implementation mode, the one or more user interfaces further include a third input interface configured to receive one or more user inputs for adjusting the demand for the one or more product components; wherein the computer-implemented method further includes: calculating an adjusted maximum consumption amount of a corresponding material in the first group based on an adjusted demand for the one or more product components; comparing the adjusted maximum consumption amount of the corresponding material in the first group with an available inventory amount of the corresponding material in the first group; and re-determining whether there is overstock or shortage in the corresponding material in the first group.

In an exemplary implementation mode, the method further includes: receiving a material state query instruction input by a user through the first input interface; in response to the material state query instruction, acquiring, from the data source, at least one of remaining amounts, overstock states, shortage states, shortage amounts of the plurality of materials for manufacturing the one or more product components and a plurality of next-level materials of the plurality of materials.

In a second aspect, an embodiment of the present disclosure provides a computer-implemented method, including: acquiring data of a plurality of next-level materials of one or more materials with shortage for manufacturing the one or more product components; wherein the data of the plurality of next-level materials of the one or more materials with shortage includes available inventory amounts of the plurality of next-level materials; calculating maximum consumption amounts of the plurality of next-level materials with respect to at least one of the one or more materials with shortage; determining whether there is shortage in the one or more materials with shortage according to a maximum consumption amount and an available inventory amount of a corresponding material of the plurality of next-level materials.

In an exemplary implementation mode, before acquiring the data of the plurality of next-level materials of the one or more materials with shortage for manufacturing the one or more product components, the method further includes: acquiring data of a plurality of materials for manufacturing one or more product components, wherein the data of the plurality of materials includes available inventory amounts of the plurality of materials; calculating maximum consumption amounts of the plurality of materials with respect to at least one of the one or more product components; determining whether there is shortage in one or more materials for manufacturing the one or more product components according to a maximum consumption amount of a corresponding material of the plurality of materials and an available inventory amount of the corresponding material of the plurality of materials.

In an exemplary implementation mode, the method further includes: determining whether there is a next-level material for a material with shortage when it is determined that there is shortage in the plurality of materials for manufacturing the one or more product components; acquiring data of a plurality of next-level materials of one or more materials with shortage for manufacturing the one or more product components when it is determined that there is the next-level material for the material with shortage.

In an exemplary implementation mode, the data of the plurality of materials includes information on substitution relationships among the plurality of materials; before acquiring the data of the plurality of next-level materials of the one or more materials with shortage for manufacturing the one or more product components, the method further includes: discriminating one or more materials with shortage in a second group from the one or more materials with shortage according to the information on the substitution relationships among the plurality of materials; wherein the one or more materials with shortage in the second group are non-substitutable materials with respect to at least one of the one or more product components.

In an exemplary implementation mode, the data of the plurality of next-level materials further includes information on substitution relationships among the next-level materials; before calculating the maximum consumption amounts of the plurality of next-level materials with respect to at least one of the one or more materials with shortage, the method further includes: discriminating data of one or more next-level materials in a third group and data of one or more next-level materials in a fourth group from data of the one or more materials with shortage in the second group according to the information on the substitution relationships among the next-level materials, wherein the one or more next-level materials in the third group are substitutable materials with respect to at least one of the one or more materials with shortage in the second group, and the one or more next-level materials in the fourth group are non-substitutable materials with respect to at least one of the one or more materials with shortage in the second group.

In an exemplary implementation mode, the calculating maximum consumption amounts of the plurality of materials with respect to at least one of the one or more product components includes: calculating a maximum consumption amount of the one or more materials in the second group with respect to the one or more product components according to data of the one or more materials in the second group; the determining whether there is shortage in one or more materials for manufacturing the one or more product components according to a maximum consumption amount of a corresponding material of the plurality of materials and an available inventory amount of the corresponding material of the plurality of materials includes: calculating a remaining amount of one or more materials with shortage in the second group according to an available inventory amount of one or more materials in the second group and a maximum consumption amount of the one or more materials in the second group, and determining whether there is shortage in the one or more materials in the second group according to the remaining amount of the one or more materials in the second group.

In an exemplary implementation mode, when it is determined that there is shortage in one or more materials in the second group, the method further includes: calculating a shortage amount of the one or more materials with shortage in the second group according to an available inventory amount of the one or more materials with shortage in the second group and a maximum consumption amount of the one or more materials with shortage in the second group.

In an exemplary implementation mode, the calculating maximum consumption amounts of the plurality of materials with respect to at least one of the one or more product components includes: calculating a maximum consumption amount of one or more materials with shortage in the second group with respect to at least one of the one or more product components; the determining whether there is shortage in one or more materials for manufacturing the one or more product components according to a maximum consumption amount of a corresponding material of the plurality of materials and an available inventory amount of the corresponding material of the plurality of materials includes: calculating a remaining amount of one or more materials with shortage in the second group according to an available inventory amount of one or more materials with shortage in the second group and a maximum consumption amount of one or more materials with shortage in the second group, and determining whether there is shortage in one or more materials with shortage in the second group according to the remaining amount of one or more materials with shortage in the second group; when it is determined that there is shortage in one or more materials with shortage in the second group, the method further includes: obtaining a shortage amount of the one or more materials with shortage in the second group according to the remaining amount of the one or more materials with shortage in the second group.

In an exemplary implementation mode, the data of the next-level materials further includes values of unit consumption of the plurality of next-level materials for manufacturing the one or more materials with shortage in the second group; the calculating maximum consumption amounts of the plurality of next-level materials with respect to at least one of the one or more materials with shortage includes: using a sum of, shortage amounts of one or more materials with shortage in the second group requiring one or more next-level materials in the fourth group as non-substitutable materials multiplied by values of unit consumption of corresponding next-level materials in the fourth group for manufacturing one or more corresponding materials with shortage in the second group respectively, to obtain a maximum consumption amount of the one or more next-level materials in the fourth group with respect to the one or more materials with shortage in the second group; the determining whether there is shortage in the one or more materials with shortage according to the maximum consumption amount and the available inventory amount of the corresponding material of the plurality of next-level materials includes: using an available inventory amount of one or more next-level materials in the fourth group to subtract a maximum consumption amount of the one or more next-level materials in the fourth group to obtain a remaining amount of the one or more next-level materials in the fourth group; when the remaining amount of the one or more next-level materials in the fourth group is less than 0, determining that there is shortage in one or more materials in the fourth group.

In an exemplary implementation mode, when the remaining amount of the one or more next-level materials in the fourth group is greater than 0, the method further includes: according to the information on the substitution relationships among the next-level materials, determining whether the one or more next-level materials in the fourth group are substitutable materials with respect to at least one of one or more materials with shortage in the first group.

In an exemplary implementation mode, when it is determined that the one or more next-level materials in the fourth group are not substitutable materials with respect to the one or more materials with shortage in the first group, determining there is overstock in one or more materials in the fourth group.

In an exemplary implementation mode, after the obtaining the remaining amount of the one or more next-level materials in the fourth group, the method further includes: updating the available inventory amount of the corresponding next-level materials in the fourth group with the remaining amount of one or more next-level materials in the fourth group.

In an exemplary implementation mode, the calculating maximum consumption amounts of the plurality of next-level materials with respect to at least one of the one or more materials with shortage includes: calculating a maximum consumption amount of one or more next-level materials in a third group with respect to one or more materials with shortage in a second group using a third linear programming model; the determining whether there is shortage in the one or more materials with shortage according to a maximum consumption amount and an available inventory amount of a corresponding material of the plurality of next-level materials includes: using an available inventory amount of one or more next-level materials in the third group to subtract a maximum consumption amount of the one or more next-level materials in the third group to obtain a remaining amount of the one or more next-level materials in the third group; when the remaining amount of the one or more next-level materials in the third group is less than 0, determining that there is shortage in the one or more next-level materials in the third group.

In an exemplary implementation mode, a third objective function of the third linear programming model is expressed as follows.

$$obj 3 = max {\sum }_{i = 1}^{N} {d}_{i} * {x}_{i} .$$

Herein, xᵢ represents a satisfiable amount of a corresponding next-level material in the third group for preparation of a corresponding material with shortage in the second group; dᵢ represents a value of unit consumption of a corresponding next-level material in the third group with respect to one or more corresponding materials with shortage in the second group; N is a positive integer, N≥1.

In an exemplary implementation mode, the third objective function is constrained by a first constraint function, and the first constraint function is expressed as follows.

$${\sum }_{{x}_{i} ∈ ( {Q}_{l} , {G}_{j} )} {x}_{i} \leq {Q}_{l} .$$

Herein, Qₗ represents shortage amount of an l-th material with shortage in the second group; (Qₗ, Gⱼ) represents a set of variables (which may be a collection of variables) of a j-th group of next-level materials with respect to the l-th material with shortage, and a plurality of next-level materials in the j-th group are substitutable for each other when producing the l-th material with shortage; 0≤xᵢ≤Qₗ; 1≤j≤J, wherein J represents a total number of groups of next-level materials that are substitutable for each other when producing the l-th material with shortage.

In an exemplary implementation mode, the third objective function is constrained by a second constraint function, and the second constraint function is expressed as follows.

$${\sum }_{{x}_{i} ∈ {X}_{m}} {d}_{i} * {x}_{i} \leq {C}_{m} .$$

Herein, Cₘ represents an available inventory amount of an m-th type of next-level material in the third group; Xₘ represents a set of variables (which may be a collection of variables) of an m-th next-level material; 1≤m≤M, wherein M represents a total number of types of next-level materials in the third group.

In an exemplary implementation mode, the data of the plurality of materials includes information on substitution relationships among the plurality of materials and a demanded amount for one or more product components; before acquiring the data of the plurality of next-level materials of the one or more materials with shortage for manufacturing the one or more product components, the method further includes: discriminating one or more materials in a first group from the plurality of materials according to the information on the substitution relationships among the plurality of materials, wherein the one or more materials in the first group are substitutable materials with respect to at least one of the one or more product components; the calculating maximum consumption amounts of the plurality of materials with respect to at least one of the one or more product components includes: calculating a maximum consumption amount of the one or more materials in the first group with respect to the one or more product components according to data of the one or more materials in the first group; the determining whether there is shortage in one or more materials for manufacturing the one or more product components according to a maximum consumption amount of a corresponding material of the plurality of materials and an available inventory amount of the corresponding material of the plurality of materials includes: acquiring a satisfiable amount of one or more substitutable material groups in the first group with respect to the one or more product components when a consumption amount of one or more materials in the first group with respect to the one or more product components is a maximum consumption amount, and determining whether there is shortage in the one or more substitutable material groups in the first group with respect to a corresponding product component according to the satisfiable amount of the one or more substitutable material groups in the first group with respect to the corresponding product component and a demanded amount for the one or more product components in the first group.

In an exemplary implementation mode, the determining whether there is a next-level material for a material with shortage when it is determined that there is shortage in the plurality of materials for manufacturing the one or more product components includes: determining whether there is a next-level material for a material group with shortage in the first group when it is determined that there is shortage in one or more substitutable material groups in the first group with respect to a corresponding product component; the acquiring data of the plurality of next-level materials of one or more materials with shortage for manufacturing the one or more product components when it is determined that there is the next-level material for the material with shortage includes: acquiring material data of one or more next-level materials of one or more material groups with shortage in the first group when it is determined that there is a next-level material for a material group with shortage in the first group.

In an exemplary implementation mode, the calculating maximum consumption amounts of the plurality of next-level materials with respect to at least one of the one or more materials with shortage includes: taking a plurality of next-level materials of one or more material groups with shortage in the first group as one or more next-level materials in a fifth group, calculating a maximum consumption amount of one or more next-level materials in the fifth group with respect to a product component corresponding to one or more material groups with shortage in the first group according to material data of the one or more next-level materials in the fifth group; the determining whether there is shortage in the one or more materials with shortage according to a maximum consumption amount and an available inventory amount of a corresponding material of the plurality of next-level materials includes: calculating a remaining amount of one or more next-level materials in the fifth group according to an available inventory amount of one or more next-level materials in the fifth group and a maximum consumption amount of one or more next-level materials in the fifth group with respect to the product component corresponding to one or more corresponding material groups with shortage in the first group, and determining whether there is shortage in the one or more next-level materials in the fifth group according to the remaining amount of the one or more next-level materials in the fifth group.

In an exemplary implementation mode, when it is determined that there is shortage in one or more substitutable material groups in the first group with respect to the corresponding product component, the method further includes: calculating a shortage amount of one or more substitutable material groups in the first group with respect to the corresponding product component according to the satisfiable amount of one or more substitutable material groups in the first group with respect to the corresponding product component and a demanded amount of a material with shortage in the first group; when it is determined that there is shortage in one or more next-level materials in the fifth group, the method further includes: calculating a sixth shortage value according to a satisfiable amount of one or more next-level materials in the fifth group for preparation of a corresponding material with shortage in the first group and a shortage amount of a corresponding material group with shortage in the first group, and updating the shortage amount of the corresponding material group with shortage in the first group with the sixth shortage value; acquiring a configuration parameter, reallocating a shortage amount of a material with shortage in the corresponding material group with shortage in the first group according to the configuration parameter, updating a shortage amount of a corresponding material in the first group with a reallocated shortage amount.

In an exemplary implementation mode, the method further includes: when it is determined that there is shortage in the one or more next-level materials in the fifth group, acquiring a configuration parameter of a next-level material, reallocating a shortage amount of a corresponding next-level material with shortage in the fifth group according to the configuration parameter of the next-level material, and updating the shortage amount of the corresponding next-level material in the fifth group with a reallocated shortage amount.

In an exemplary implementation mode, the method further includes: adjusting a demand for the one or more product components to minimize overstock or shortage in the next-level materials when it is determined that there is overstock or shortage in the one or more materials with shortage according to a maximum consumption amount and an available inventory amount of a corresponding material of the plurality of next-level materials; and producing the one or more product components based on an adjusted demand for the one or more product components.

In an exemplary implementation mode, the method further includes: generating one or more user interfaces.

Herein, the one or more user interfaces include a first output interface configured to display a material state of a corresponding material in at least one of a first group to a fifth group.

In an exemplary implementation mode, the one or more user interfaces further include the first input interface configured to receive one or more user inputs for querying a database; wherein the data of the plurality of materials is stored in the database.

Herein, the computer-implemented method further includes: receiving, from the first input interface, user selection of one or more conditions, wherein the user selection is for selecting a material state associated with the one or more conditions; and in response to the user selection, querying the database to determine one or more material states in the database associated with the one or more conditions; the one or more conditions include at least one of an overstock state of an overstocked material and a shortage state of a material with shortage; the one or more user interfaces further include a second output interface configured to display one or more overstocked materials or materials with shortage as a result of querying the database.

In an exemplary implementation mode, the one or more user interfaces further include a second input interface configured to receive one or more user inputs for adjusting a priority of a corresponding material in a first group.

Herein, the computer-implemented method further includes re-determining whether the corresponding material in the first group is overstocked or short based on an adjusted priority of the corresponding material in the first group.

In an exemplary implementation mode, the one or more user interfaces further include a third input interface configured to receive one or more user inputs for adjusting the demand for the one or more product components.

Herein, the computer-implemented method further includes: calculating an adjusted maximum consumption amount of a corresponding material in the first group based on an adjusted demand for the one or more product components; comparing the adjusted maximum consumption amount of the corresponding material in the first group with an available inventory amount of the corresponding material in the first group; and re-determining whether there is overstock or shortage in the corresponding material in the first group.

In a third aspect, an embodiment of the present disclosure also provides an apparatus for managing production of one or more products, including: a memory; and one or more processors.

Herein, the memory and the one or more processors are connected with each other; the memory stores computer-executable instructions for controlling the one or more processors to perform following operations: acquiring data of a plurality of next-level materials of one or more materials with shortage for manufacturing one or more product components; wherein the data of the plurality of next-level materials of the one or more materials with shortage includes available inventory amounts of the plurality of next-level materials; calculating maximum consumption amounts of the plurality of next-level materials with respect to at least one of the one or more materials with shortage; and determining whether there is shortage in the one or more materials with shortage according to a maximum consumption amount and an available inventory amount of a corresponding material of the plurality of next-level materials.

In a fourth aspect, an embodiment of the present disclosure also provides a computer program product including a non-transitory tangible computer-readable medium having computer-readable instructions thereon, the computer-readable instructions are able to be executed by a processor to enable the processor to perform following operations: acquiring data of a plurality of next-level materials of one or more materials with shortage for manufacturing one or more product components; wherein the data of the plurality of next-level materials of the one or more materials with shortage includes available inventory amounts of the plurality of next-level materials; calculating maximum consumption amounts of the plurality of next-level materials with respect to at least one of the one or more materials with shortage; and determining whether there is shortage in the one or more materials with shortage according to a maximum consumption amount and an available inventory amount of a corresponding material of the plurality of next-level materials.

In a fifth aspect, an embodiment of the present disclosure also provides an apparatus for managing production of one or more products, including: a memory; and one or more processors.

Herein, the memory and the one or more processors are connected with each other; the memory stores computer-executable instructions for controlling the one or more processors to perform following operations: receiving a material query instruction input by a user through a first input interface; in response to the material query instruction, acquiring, from a data source, data of a plurality of materials for manufacturing one or more product components, wherein the data of the plurality of materials includes available inventory amounts of the plurality of materials; calculating maximum consumption amounts of the plurality of materials with respect to at least one of the one or more product components; and determining whether there is shortage in one or more materials for manufacturing the one or more product components according to a maximum consumption amount of a corresponding material of the plurality of materials and an available inventory amount of the corresponding material of the plurality of materials.

In a sixth aspect, an embodiment of the present disclosure also provides a computer program product including a non-transitory tangible computer-readable medium having computer-readable instructions thereon, the computer-readable instructions are able to be executed by a processor to enable the processor to perform following operations: receiving a material query instruction input by a user through a first input interface; in response to the material query instruction, acquiring, from a data source, data of a plurality of materials for manufacturing one or more product components, wherein the data of the plurality of materials includes available inventory amounts of the plurality of materials; calculating maximum consumption amounts of the plurality of materials with respect to at least one of the one or more product components; and determining whether there is shortage in one or more materials for manufacturing the one or more product components according to a maximum consumption amount of a corresponding material of the plurality of materials and an available inventory amount of the corresponding material of the plurality of materials.

Other aspects may be comprehended after drawings and detailed description are read and understood.

### BRIEF DESCRIPTION OF DRAWINGS

Accompanying drawings are used to provide an understanding of technical solutions of the embodiments of the present disclosure, form a part of the specification, and are used to explain, together with the embodiments of the present disclosure, the technical solutions of the embodiments of the present disclosure but are not intended to form limitations on the technical solutions of the present disclosure.

FIG. 1 is a flowchart of a computer-implemented method according to an embodiment of the present disclosure.

FIG. 2 is a flowchart of a computer-implemented method according to an exemplary embodiment of the present disclosure.

FIGS. 3a and 3b are flowcharts of a computer-implemented method according to an exemplary embodiment of the present disclosure.

FIG. 4 is a schematic diagram of one or more interfaces according to an exemplary embodiment of the present disclosure.

FIG. 5 is a schematic diagram of a third output interface according to an exemplary embodiment of the present disclosure.

FIG. 6 is a schematic diagram of modules of an apparatus for managing production of one or more products according to an embodiment of the present disclosure.

FIG. 7 is a schematic diagram of a structure of an apparatus for managing production of one or more products according to an exemplary embodiment of the present disclosure.

### DETAILED DESCRIPTION

The embodiments of the present disclosure will be described in detail below with reference to the accompanying drawings. It is to be noted that the embodiments and features in the embodiments of the present disclosure may be randomly combined with each other if there is no conflict.

Unless otherwise defined, technical terms or scientific terms used in the embodiments of the present disclosure shall have common meanings as construed by those of ordinary skills in the art to which the present disclosure pertains. “First”, “second”, and similar terms used in the embodiments of the present disclosure do not represent any order, quantity, or importance, but are only used for distinguishing different components. “Include”, “contain”, or a similar word means that an element or object appearing before the word covers an element or object listed after the word and equivalent thereof and does not exclude other elements or objects.

In a management process of product production, in a case that there are many kinds of products produced and a material sharing relationship and a substitution relationship involved are complex, it is difficult to control and manage a common material and substitution of materials, and there are often material wastage due to material overstock and prolongation of a production cycle (even delaying a delivery time of products) due to material shortage, resulting in an increase in a cost of material management; when the demand for products and the engineering of the manufacturing process change rapidly in a short time, material management becomes more difficult, and a phenomenon of material overstock or shortage becomes more serious.

An embodiment of the present disclosure provides a computer-implemented method, which may include: receiving a material query instruction input by a user through a first input interface; in response to the material query instruction, acquiring, from a data source, data about a plurality of materials for manufacturing one or more product components, wherein the data of the plurality of materials includes available inventory amounts of the plurality of materials; calculating maximum consumption amounts of the plurality of materials with respect to at least one of the one or more product components; and determining whether there is shortage in one or more materials for manufacturing the one or more product components according to a maximum consumption amount of a corresponding material of the plurality of materials and an available inventory amount of the corresponding material of the plurality of materials.

According to the computer-implemented method provided by the embodiment of the present disclosure, a material query instruction input by a user is received through a first input interface; in response to the material query instruction, data about a plurality of materials for manufacturing one or more product components is acquired from a data source, wherein the data of the plurality of materials includes available inventory amounts of the plurality of materials; maximum consumption amounts of the plurality of materials with respect to at least one of the one or more product components are calculated; and whether there is shortage in one or more materials for manufacturing the one or more product components is determined according to a maximum consumption amount of a corresponding material of the plurality of materials and an available inventory amount of the corresponding material of the plurality of materials; a technical solution according to the embodiment of the present disclosure may solve a problem of material overstock or shortage in a process of material management.

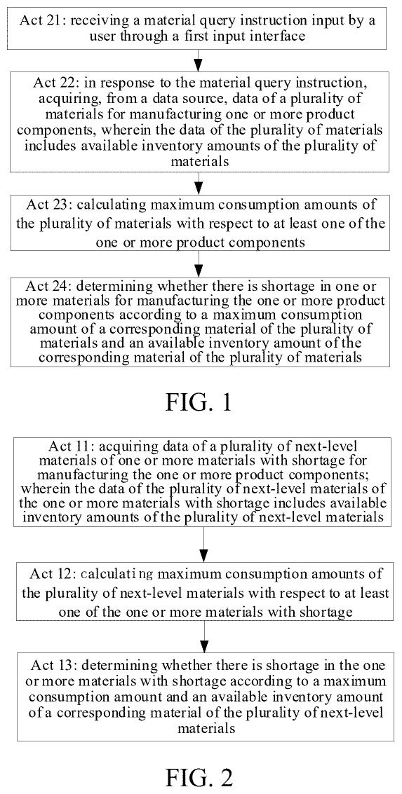

As shown in FIG. 1, the computer-implemented method according to the embodiment of the present disclosure may include acts 21 to 24.

Act 21: receiving a material query instruction input by a user through a first input interface.

Act 22: in response to the material query instruction, acquiring, from a data source, data about a plurality of materials for manufacturing one or more product components, wherein the data of the plurality of materials includes available inventory amounts of the plurality of materials.

Act 23: calculating maximum consumption amounts of the plurality of materials with respect to at least one of the one or more product components.

Act 24: determining whether there is shortage in one or more materials for manufacturing the one or more product components according to a maximum consumption amount of a corresponding material of the plurality of materials and an available inventory amount of the corresponding material of the plurality of materials.

In an exemplary implementation mode, the data source may be a database, or the data source may be a link address (or database address) according to which a corresponding database is accessed.

In an exemplary implementation mode, maximum consumption amounts of the plurality of materials with respect to at least one of the one or more product components may be understood as a target demanded amount of the plurality of materials when preparing the one or more product components.

In the computer-implemented method according to the embodiment of the present disclosure, in a process of producing one or more product components, when there is a material shortage, a next-level material of a material with shortage may be consumed to supplement the material with shortage, and it is determined for the material with shortage after supplement whether there is shortage, on one hand, a consumption amount of the next-level material may be maximized, and overstock of the next-level material may be avoided, and on the other hand, the material with shortage may be replenished in time, thereby solving a problem of material overstock or shortage in the process of material management to a great extent.

In an exemplary implementation mode, the above method may further include: when it is determined in the act 24 there is shortage in the plurality of materials for manufacturing the one or more product components, acts 241 to 244 are performed.

Act 241: determining whether there is a next-level material for the material with shortage.

Act 242: acquiring data of a plurality of next-level materials of one or more materials with shortage for manufacturing the one or more product components when it is determined that there is a next-level material for the material with shortage, the data of the plurality of next-level materials of the one or more materials with shortage includes available inventory amounts of the plurality of next-level materials.

Act 243: calculating maximum consumption amounts of the plurality of next-level materials with respect to at least one of the one or more materials with shortage.

Act 244: determining whether there is shortage in the plurality of next-level materials according to a maximum consumption amount and an available inventory amount of a corresponding material of the plurality of next-level materials.

In an exemplary implementation mode, the data of the plurality of materials includes information on substitution relationships among the plurality of materials, and the data of the plurality of next-level materials further includes information on substitution relationships among the next-level materials.

Before acquiring the data of the plurality of next-level materials of the one or more materials with shortage for manufacturing the one or more product components in act 242, the method may further include: discriminating one or more materials with shortage in a second group from the one or more materials with shortage according to the information on the substitution relationships among the plurality of materials; wherein the one or more materials with shortage in the second group are non-substitutable materials with respect to at least one of the one or more product components.

Before calculating the maximum consumption amounts of the plurality of next-level materials with respect to at least one of the one or more materials with shortage in act 243, the method may further include: discriminating, data of one or more next-level materials in a third group and data of one or more next-level materials in a fourth group from data of the one or more materials with shortage in the second group according to the information on the substitution relationships among the next-level materials, wherein the one or more next-level materials in the third group are substitutable materials with respect to at least one of the one or more materials with shortage in the second group, and the one or more next-level materials in the fourth group are non-substitutable materials with respect to at least one of the one or more materials with shortage in the second group.

In an exemplary implementation mode, in act 23, the calculating maximum consumption amounts of the plurality of materials with respect to at least one of the one or more product components may include: calculating a maximum consumption amount of the one or more materials in the second group with respect to the one or more product components according to data of the one or more materials in the second group.

In act 24, the determining whether there is shortage in one or more materials for manufacturing the one or more product components according to a maximum consumption amount of a corresponding material of the plurality of materials and an available inventory amount of the corresponding material of the plurality of materials may include: calculating remaining amounts of the one or more materials in the second group according to an available inventory amount of the one or more materials in the second group and a maximum consumption amount of the one or more materials in the second group, and determining whether there is shortage in the one or more materials in the second group according to the remaining amounts of the one or more materials in the second group.

In an exemplary implementation mode, the calculating the maximum consumption amount of the one or more materials in the second group with respect to the one or more product components according to data of the one or more materials in the second group may include: using a sum of, a demanded amount for one or more product components requiring one or more materials in the second group as non-substitutable materials multiplied by values of corresponding unit consumption of corresponding materials in the second group with respect to manufacturing the one or more product components respectively, to obtain the maximum consumption amount of the one or more materials in the second group with respect to the one or more product components.

In an exemplary implementation mode, when it is determined that there is shortage in one or more materials in the second group, the method may further include: calculating shortage amounts of the one or more materials with shortage in the second group according to an available inventory amount of the one or more materials with shortage in the second group and the maximum consumption amount of the one or more materials with shortage in the second group.

In an exemplary implementation mode, remaining amounts of one or more materials with shortage in the second group may be calculated according to an available inventory amount of the one or more materials with shortage in the second group and the maximum consumption amount of the one or more materials with shortage in the second group, for example, the maximum consumption amount of the one or more materials with shortage in the second group is subtracted from the available inventory amount of the one or more materials with shortage in the second group to obtain remaining amounts of the one or more materials with shortage in the second group, when the remaining amounts of the one or more materials with shortage in the second group is less than 0, it is determined that there is shortage in one or more materials with shortage in the second group, and a shortage amount may be a negative of a remaining amount (if the remaining amount is less than 0, then a value of the shortage amount may be greater than 0).

In an exemplary implementation mode, the calculating maximum consumption amounts of the plurality of next-level materials with respect to at least one of the one or more materials with shortage in act 243 may include: act 231: calculating a maximum consumption amount of one or more next-level materials in the fourth group with respect to one or more materials with shortage in the second group.

The determining whether there is shortage in the plurality of next-level materials according to a maximum consumption amount and an available inventory amount of a corresponding material of the plurality of next-level materials in act 244 may include: using an available inventory amount of one or more next-level materials in the fourth group to subtract a maximum consumption amount of the one or more next-level materials in the fourth group to obtain a remaining amount of the one or more next-level materials in the fourth group, and determining whether there is shortage in the one or more next-level materials in the fourth group according to the remaining amount of the one or more next-level materials in the fourth group.

In an exemplary implementation mode, the calculating maximum consumption amount of one or more next-level materials in the fourth group with respect to one or more materials with shortage in the second group includes: using a sum of, a shortage amount for one or more materials with shortage in the second group requiring one or more next-level materials in the fourth group as non-substitutable materials multiplied by values of unit consumption of corresponding next-level materials in the fourth group for manufacturing one or more corresponding materials with shortage in the second group respectively, to obtain a maximum consumption amount of the one or more next-level materials in the fourth group with respect to the one or more materials with shortage in the second group.

In an exemplary implementation mode, when the remaining amount of the one or more next-level materials in the fourth group is less than 0, it is determined that there is shortage in one or more next-level materials in the fourth group.

In an exemplary implementation mode, the method may further include: when it is determined that there is shortage in one or more next-level materials in the fourth group, obtaining a shortage amount of the one or more next-level materials in the fourth group according to a remaining amount of the one or more next-level materials in the fourth group, and displaying a shortage amount and a shortage state of the one or more next-level materials in the fourth group through a first output interface; when it is determined that there is no shortage in the one or more next-level materials in the fourth group and the remaining amount is 0, displaying the remaining amount and a material state of the one or more next-level materials in the fourth group through the first output interface (the material state may include a state in which a material just meet production requirements); when it is determined that there is no shortage in the one or more next-level materials in the fourth group and the remaining amount is greater than 0, according to the information on the substitution relationships among the next-level materials, determining whether the one or more next-level materials in the fourth group are substitutable materials with respect to at least one of one or more materials with shortage in the first group; when it is determined that the one or more next-level materials in the fourth group are not substitutable materials with respect to the one or more materials with shortage in the first group, determining that there is overstock in the one or more next-level materials in the fourth group, and displaying an overstock state and a remaining amount of the one or more next-level materials in the fourth group through the first output interface.

In an exemplary implementation mode, the calculating maximum consumption amounts of the plurality of next-level materials with respect to at least one of the one or more materials with shortage in act 243 may include: calculating a maximum consumption amount of one or more semi-finished components in the third group with respect to one or more materials with shortage in the second group using a third linear programming model.

The determining whether there is shortage in the plurality of next-level materials according to a maximum consumption amount and an available inventory amount of a corresponding material of the plurality of next-level materials in act 244 may include: using an available inventory amount of one or more next-level materials in the third group to subtract a maximum consumption amount of the one or more next-level materials in the third group to obtain a remaining amount of the one or more next-level materials in the third group, and determining whether there is shortage in the one or more next-level materials in the third group according to the remaining amount of the one or more next-level materials in the third group.

In an exemplary implementation mode, the method may further include: when it is determined that there is shortage in the one or more next-level materials in the third group, obtaining a shortage amount of the one or more next-level materials in the third group according to the remaining amount of the one or more next-level materials in the third group, and displaying the shortage amount and a shortage state of the one or more next-level materials in the third group through a first output interface; when it is determined that there is no shortage in the one or more next-level materials in the third group and the remaining amount is 0, displaying the remaining amount and a material state of the one or more next-level materials in the third group through the first output interface; when it is determined that there is no shortage in the one or more next-level materials in the third group and the remaining amount is greater than 0, according to the information on the substitution relationships among the next-level materials, determining whether the one or more next-level materials in the third group are substitutable materials with respect to at least one of the one or more materials with shortage in the first group; when it is determined that one or more materials in the third group are not substitutable materials with respect to the one or more materials with shortage in the first group, determining that there is overstock in the one or more next-level materials in the third group, and displaying an overstock state and the remaining amount of the one or more next-level materials in the third group through the first output interface.

In an exemplary implementation mode, after obtaining the shortage amount of the one or more next-level materials in the third group according to the remaining amount of the one or more next-level materials in the third group when it is determined that there is shortage in the one or more next-level materials in the third group, the method may further include: acquiring a configuration parameter, reallocating a shortage amount of a material with shortage in a corresponding material group with shortage in the third group according to the configuration parameter, updating shortage amount of a corresponding material in the third group using a reallocated shortage amount. In an exemplary implementation mode, the configuration parameter may include, but is not limited to, a material priority, which may be set according to actual business requirements, for example, the shortage amount may be allocated according to a size of a shared quantity of a substitution material and a size of possibility of using the substitution material. In an exemplary implementation mode, obtaining the configuration parameter may include: receiving configuration parameter data input by a user through a first input interface; reallocating a shortage amount of a material with shortage in a corresponding material group with shortage in the third group according to the configuration parameter data input by the user, which enables more flexible material management and minimizes material overstock and shortage.

In an exemplary implementation mode, a third objective function of the third linear programming model is expressed as follows.

$$obj 3 = max {\sum }_{i = 1}^{N} {d}_{i} * {x}_{i} .$$

Herein, xᵢ represents a satisfiable amount of a corresponding next-level material in the third group for preparation of a corresponding material with shortage in the second group; dᵢ represents a value of unit consumption of a corresponding next-level material in the third group with respect to one or more corresponding materials with shortage in the second group; N is a positive integer, N≥1.

In an exemplary implementation mode, the third objective function is constrained by a first constraint function, and the first constraint function is expressed as follows.

$${\sum }_{{x}_{i} ∈ ( {Q}_{l} , {G}_{j} )} {x}_{i} \leq {Q}_{l} .$$

Herein, Qₗ represents shortage amount of an l-th material with shortage in the second group; (Qₗ, Gⱼ) represents a set of variables (which may be a collection of variables) for a j-th group of next-level materials with respect to the l-th material with shortage, and a plurality of next-level materials in the j-th group may be substituted for each other in production of the l-th material with shortage; 0≤xᵢ≤Qₗ; 1≤j≤J, wherein J represents a total number of groups of next-level materials that may be substituted for each other in production of the l-th material with shortage.

In an exemplary implementation mode, the third objective function is constrained by a second constraint function, and the second constraint function is expressed as follows.

$${\sum }_{{x}_{i} ∈ {X}_{m}} {d}_{i} * {x}_{i} \leq {C}_{m} .$$

Herein, Cₘ represents an available inventory amount of an m-th type of next-level material in the third group; Xₘ represents a set of variables (which may be a collection of variables) for an m-th next-level material; 1≤m≤M, wherein M represents a total number of types of next-level materials in the third group.

In an exemplary implementation mode, the data of the plurality of materials may include information on substitution relationships among the plurality of materials and a demanded amount for one or more product components.

Before acquiring the data of the plurality of next-level materials of the one or more materials with shortage for manufacturing the one or more product components in act 242, the method may further include: discriminating one or more materials in the first group from the plurality of materials according to the information on the substitution relationships among the plurality of materials, wherein the one or more materials in the first group are substitutable materials with respect to at least one of the one or more product components.

The calculating maximum consumption amounts of the plurality of materials with respect to at least one of the one or more product components in act 23 may include: calculating a maximum consumption amount of the one or more materials in the first group with respect to the one or more product components according to data of the one or more materials in the first group.

The determining whether there is shortage in one or more materials for manufacturing the one or more product components according to a maximum consumption amount of a corresponding material of the plurality of materials and an available inventory amount of the corresponding material of the plurality of materials in act 24 may include: acquiring a satisfiable amount of one or more substitutable material groups in the first group with respect to the one or more product components when a consumption amount of one or more materials in the first group with respect to the one or more product components is a maximum consumption amount, and determining whether there is shortage in the one or more substitutable material groups in the first group with respect to a corresponding product component according to the satisfiable amount of the one or more substitutable material groups in the first group with respect to the one or more product components and the demanded amount for the one or more product components.

In an exemplary implementation mode, the determining whether there is a next-level material for a material with shortage when it is determined that there is shortage in one or more materials for manufacturing the one or more product components in act 24 may include: determining whether there is a next-level material for a material group with shortage in the first group when it is determined that there is shortage in one or more substitutable material groups in the first group with respect to a corresponding product component.

The acquiring data of a plurality of next-level materials of one or more materials with shortage for manufacturing the one or more product components when it is determined that there is a next-level material for the material with shortage in act 242 may include: acquiring material data of one or more next-level materials of one or more material groups with shortage in the first group when it is determined that there is a next-level material for a material group with shortage in the first group.

The calculating maximum consumption amounts of the plurality of next-level materials with respect to at least one of the one or more materials with shortage in act 243 may include: taking a plurality of next-level materials of one or more material groups with shortage in the first group as one or more next-level materials in a fifth group, calculating a maximum consumption amount of one or more next-level materials in the fifth group with respect to a product component corresponding to one or more material groups with shortage in the first group according to material data of the one or more next-level materials in the fifth group.

The determining whether there is shortage in the plurality of next-level materials according to a maximum consumption amount and an available inventory amount of a corresponding material of the plurality of next-level materials in act 244 may include: calculating a remaining amount of one or more next-level materials in the fifth group according to an available inventory amount of one or more next-level materials in the fifth group and a maximum consumption amount of one or more next-level materials in the fifth group with respect to a product component corresponding to one or more corresponding material groups with shortage in the first group, and determining whether there is shortage in the one or more next-level materials in the fifth group according to the remaining amount of the one or more next-level materials in the fifth group.

In an exemplary implementation mode, when it is determined that there is shortage in one or more substitutable material groups in the first group with respect to a corresponding product component, the method may further include: calculating a shortage amount of one or more substitutable material groups in the first group with respect to a corresponding product component according to a satisfiable amount of one or more substitutable material groups in the first group with respect to the corresponding product component and a demanded amount of a material with shortage in the first group.

When it is determined that there is shortage in one or more next-level materials in the fifth group, the method may further include acts H1 and H2.

Act H1: calculating a sixth shortage value according to a satisfiable amount of one or more next-level materials in the fifth group for preparation of a corresponding material with shortage in the first group and shortage amount of a corresponding material group with shortage in the first group, and updating the shortage amount of the corresponding material group with shortage in the first group using the sixth shortage value.

Act H2: acquiring a configuration parameter, reallocating shortage amount of a material with shortage in the corresponding material group with shortage in the first group according to the configuration parameter, updating a shortage amount of a corresponding material in the first group using an allocated shortage amount, and displaying the shortage amount and a shortage state of the corresponding material in the first group through the first output interface.

In an exemplary implementation mode, the method may further include: when it is determined that there is shortage in one or more next-level materials in the fifth group, acquiring a shortage amount of the one or more next-level materials in the fifth group according to the remaining amount of the one or more next-level materials in the fifth group, and displaying the shortage amount and a shortage state of the one or more next-level materials in the fifth group through the first output interface; when it is determined that there is no shortage in the one or more next-level materials in the fifth group and the remaining amount is greater than 0, outputting the remaining amount and an overstock state of the one or more next-level materials in the fifth group through the first display interface; when it is determined that there is no shortage in the one or more next-level materials in the fifth group and the remaining amount is equal to 0, outputting the remaining amount and a material state of the one or more next-level materials in the fifth group through the first display interface.

In an exemplary implementation mode, the method may further include: when it is determined that there is shortage in the one or more next-level materials in the fifth group, acquiring a configuration parameter of a next-level material, reallocating a shortage amount of a material with shortage in a corresponding next-level material group with shortage in the fifth group according to the configuration parameter of the next-level material, updating a shortage amount of a corresponding next-level material in the fifth group using a reallocated shortage amount, and displaying an updated shortage amount and a shortage state of the corresponding next-level material in the fifth group through the first output interface.

In an exemplary implementation mode, the method may further include: when it is determined that there is shortage in the one or more next-level materials in the fifth group, acquiring a configuration parameter of a next-level material, reallocating a shortage amount of a corresponding next-level material with shortage in the fifth group according to the configuration parameter of the next-level material, and updating the shortage amount of the corresponding next-level material in the fifth group using a reallocated shortage amount.

In an exemplary implementation mode, the method may further include: displaying a shortage state of a material with shortage through the first output interface (or a shortage amount of the material with shortage may be displayed, or the shortage state and a shortage amount of the material with shortage may be displayed) when it is determined that there is no next-level material for the material with shortage; when it is determined that there is no shortage in one or more materials for manufacturing one or more product components, displaying material information of the one or more materials for manufacturing the one or more product components through the first output interface (the material information may include at least one of a remaining amount and an overstock state).

In an exemplary implementation mode, the method may further include: adjusting a demand for the one or more product components to minimize overstock or shortage of a next-level material when it is determined that there is overstock or shortage in the one or more materials with shortage according to a maximum consumption amount and an available inventory amount of a corresponding material of the plurality of next-level materials; and producing the one or more product components based on an adjusted demand for the one or more product components.

In an exemplary implementation mode, the method may further include: generating one or more user interfaces; wherein the one or more user interfaces include a first output interface, the first output interface is further configured to display a material state of a corresponding material in at least one of the first group to the fifth group.

In an exemplary implementation mode, the one or more user interfaces may further include the first input interface configured to receive one or more user inputs for querying a database; the data of the plurality of materials is stored in the database; herein, the computer-implemented method further includes: receiving, from the first input interface, user selection of one or more conditions, the user selection is for selecting a material state associated with the one or more conditions; and in response to the user selection, querying the database to determine one or more material states in the database associated with the one or more conditions; the one or more conditions include at least one of an overstock state of an overstocked material and a shortage state of a material with shortage; the one or more user interfaces further include a second output interface configured to display one or more overstocked materials or materials with shortage as a result of querying the database.

In an exemplary implementation mode, the one or more user interfaces may further include a second input interface configured to receive one or more user inputs for adjusting a priority of a corresponding material in the first group; herein, the computer-implemented method further includes re-determining whether the corresponding material in the first group is overstocked or short based on an adjusted priority of the corresponding material in the first group.

In an exemplary implementation mode, the one or more user interfaces may further include a third input interface configured to receive one or more user inputs for adjusting a demand for the one or more product components; herein, the computer-implemented method further includes: calculating an adjusted maximum consumption amount of a corresponding material in the first group based on an adjusted demand for the one or more product components; comparing the adjusted maximum consumption amount of the corresponding material in the first group with an available inventory amount of the corresponding material in the first group; and re-determining whether there is overstock or shortage in the corresponding material in the first group.

In an exemplary implementation mode, the method may further include: receiving a material state query instruction input by a user through the first input interface; in response to the material state query instruction, acquiring, from the database, a plurality of materials for manufacturing the one or more product components and at least one of remaining amounts, overstock states, shortage states, shortage amounts of a plurality of next-level materials of the plurality of materials.

In an exemplary implementation mode, the material state query instruction is for querying current material information of a corresponding material, for example, the current material may be at least one material in at least one group of the first group to the fifth group described above, and the current material information may be at least one of a remaining amount or a shortage amount, an overstock state, or a shortage state of the queried material.

In an exemplary implementation mode, the above material query instruction may be understood as querying a material state after production of corresponding demanded product components, and after receiving the material query instruction input by a user, a processor may perform data processing according to a material for preparing a product component and a next-level material of the material, and acquire an overstock or shortage state of a corresponding material as well as a quantity of overstock or shortage. The above material state query instruction may be understood as querying material information of materials for preparing one or more product components and next-level materials (for example, including the overstock or shortage state and the quantity of overstock or shortage). The queried material information may be an overstock or shortage state of a corresponding material as well as a quantity of overstock or shortage obtained after the processor responds to the above material query instruction (it is not necessary to process material data again, but simply query the material data that has been processed, which may improve query efficiency), or it may be material related information before responding to the above material query instruction (simple display of corresponding material information without complex data processing may meet needs of users to simply understand related material information).

An embodiment of the present disclosure also provides a computer-implemented method, which may include: acquiring data of a plurality of next-level materials of one or more materials with shortage for manufacturing the one or more product components; wherein the data of the plurality of next-level materials of the one or more materials with shortage includes available inventory amounts of the plurality of next-level materials; calculating maximum consumption amounts of the plurality of next-level materials with respect to at least one of the one or more materials with shortage; and determining whether there is shortage in the one or more materials with shortage according to a maximum consumption amount and an available inventory amount of a corresponding material of the plurality of next-level materials.

In the computer-implemented method according to the embodiment of the present disclosure, data of a plurality of next-level materials of one or more materials with shortage for manufacturing the one or more product components is acquired, maximum consumption amounts of the plurality of next-level materials with respect to at least one of the one or more materials with shortage is calculated, it is determined whether there is shortage in the one or more materials with shortage according to a maximum consumption amount and an available inventory amount of a corresponding material of the plurality of next-level materials, in a process of producing one or more product components, when there is material shortage, a next-level material of a material with shortage is consumed to supplement the material with shortage, and it is determined for the material with shortage after supplement whether there is shortage, on one hand, consumption of the next-level material may be maximized, and overstock of the next-level material may be avoided, and on the other hand, the material with shortage may be replenished in time, thereby solving a problem of material overstock or shortage in a process of material management to a great extent.

In an exemplary implementation mode, a product component may be any product produced from a plurality of materials. Examples of product components may include semiconductor products, electronic products, chemical products, mechanically assembled products, and the like. In an exemplary implementation mode, the product component is not limited to a finished product, and may include a finished product or a semi-finished product.

As shown in FIG. 2, it is a flowchart of a computer-implemented method according to an embodiment of the present disclosure, which may include acts 11 to 13.

Act 11: acquiring data of a plurality of next-level materials of one or more materials with shortage for manufacturing one or more product components; wherein the data of the plurality of next-level materials of the one or more materials with shortage includes available inventory amounts of the plurality of next-level materials.

Act 12: calculating maximum consumption amounts of the plurality of next-level materials with respect to at least one of the one or more materials with shortage.

Act 13: determining whether there is shortage in the one or more materials with shortage according to a maximum consumption amount and an available inventory amount of a corresponding material of the plurality of next-level materials.

In an exemplary implementation mode, before acquiring the data of the plurality of next-level materials of the one or more materials with shortage for manufacturing the one or more product components in act 11, the method may further include acts 01 to 03.

Act 01: acquiring data of a plurality of materials for manufacturing one or more product components, wherein the data of the plurality of materials includes available inventory amounts of the plurality of materials.

Act 02: calculating maximum consumption amounts of the plurality of materials with respect to at least one of the one or more product components.

Act 03: determining whether there is shortage in one or more materials for manufacturing the one or more product components according to a maximum consumption amount of a corresponding material of the plurality of materials and an available inventory amount of the corresponding material of the plurality of materials.

In an exemplary implementation mode, the computer-implemented method may further include: determining whether there is a next-level material for a material with shortage when it is determined that there is shortage in the plurality of materials for manufacturing the one or more product components in act 03; and acquiring data of a plurality of next-level materials of one or more materials with shortage for manufacturing the one or more product components when it is determined that there is a next-level material for the material with shortage.

In an exemplary implementation mode, the data of the plurality of materials includes information on substitution relationships among the plurality of materials; before acquiring the data of the plurality of next-level materials of the one or more materials with shortage for manufacturing the one or more product components in act 11, the method may further include: discriminating one or more materials with shortage in the second group from the one or more materials with shortage according to the information on the substitution relationships among the plurality of materials; wherein the one or more materials with shortage in the second group are non-substitutable materials with respect to at least one of the one or more product components.

In an exemplary implementation mode, the data of the plurality of next-level materials may further include information on substitution relationships among the next-level materials; before calculating the maximum consumption amounts of the plurality of next-level materials with respect to at least one of the one or more materials with shortage in act 12, the method may further include: discriminating, data of one or more next-level materials in the third group and data of one or more next-level materials in the fourth group from data of one or more materials with shortage in the second group according to the information on the substitution relationships among the next-level materials, wherein the one or more next-level materials in the third group are substitutable materials with respect to at least one of the one or more materials with shortage in the second group, and the one or more next-level materials in the fourth group are non-substitutable materials with respect to at least one of the one or more materials with shortage in the second group.

In an exemplary implementation mode, in act 02, the calculating maximum consumption amounts of the plurality of materials with respect to at least one of the one or more product components may include: calculating a maximum consumption amount of the one or more materials in the second group with respect to the one or more product components according to data of the one or more materials in the second group; in act 03, the determining whether there is shortage in one or more materials for manufacturing the one or more product components according to a maximum consumption amount of a corresponding material of the plurality of materials and an available inventory amount of the corresponding material of the plurality of materials may include: calculating a remaining amount of the one or more materials in the second group according to an available inventory amount of the one or more materials in the second group and a maximum consumption amount of the one or more materials in the second group, and determining whether there is shortage in the one or more materials in the second group according to the remaining amount of the one or more materials in the second group.

In an exemplary implementation mode, when it is determined that there is shortage in one or more materials in the second group, the method may further include: calculating a shortage amount of the one or more materials with shortage in the second group according to an available inventory amount of the one or more materials with shortage in the second group and a maximum consumption amount of the one or more materials with shortage in the second group.

In an exemplary implementation mode, in act 02, the calculating maximum consumption amounts of the plurality of materials with respect to at least one of the one or more product components may include: calculating a maximum consumption amount of the one or more materials with shortage in the second group with respect to at least one of the one or more product components.

In act 03, the determining whether there is shortage in one or more materials for manufacturing the one or more product components according to a maximum consumption amount of a corresponding material of the plurality of materials and an available inventory amount of the corresponding material of the plurality of materials may include: calculating a remaining amount of one or more materials with shortage in the second group according to an available inventory amount of the one or more materials with shortage in the second group and a maximum consumption amount of the one or more materials with shortage in the second group, and determining whether there is shortage in one or more materials with shortage in the second group according to the remaining amount of one or more materials with shortage in the second group; when it is determined that there is shortage in one or more materials with shortage in the second group, the method may further include: obtaining a shortage amount of the one or more materials with shortage in the second group according to the remaining amount of the one or more materials with shortage in the second group.

In an exemplary implementation mode, the data of the next-level materials may further include values of unit consumption of the plurality of next-level materials for manufacturing the one or more materials with shortage in the second group.

In act 12, the calculating maximum consumption amounts of the plurality of next-level materials with respect to at least one of the one or more materials with shortage may include: using a sum of, a shortage amount of one or more materials with shortage in the second group requiring one or more next-level materials in the fourth group as non-substitutable materials multiplied by values of unit consumption of corresponding next-level materials in the fourth group for manufacturing one or more corresponding materials with shortage in the second group respectively, to obtain a maximum consumption amount of the one or more next-level materials in the fourth group with respect to the one or more materials with shortage in the second group.

In act 13, the determining whether there is shortage in the one or more materials with shortage according to a maximum consumption amount and an available inventory amount of a corresponding material of the plurality of next-level materials may include: using an available inventory amount of one or more next-level materials in the fourth group to subtract a maximum consumption amount of the one or more next-level materials in the fourth group to obtain a remaining amount of the one or more next-level materials in the fourth group; when the remaining amount of the one or more next-level materials in the fourth group is less than 0, determining that there is shortage in one or more materials in the fourth group.

In an exemplary implementation mode, when the remaining amount of the one or more next-level materials in the fourth group is greater than 0, the method may further include: according to the information on the substitution relationships among the next-level materials, determining whether the one or more next-level materials in the fourth group are substitutable materials with respect to at least one of one or more materials with shortage in the first group.

In an exemplary implementation mode, when it is determined that the one or more next-level materials in the fourth group are not substitutable materials with respect to the one or more materials with shortage in the first group, it is determined that there is overstock in the one or more next-level materials in the fourth group.

In an exemplary implementation mode, after the obtaining the remaining amount of the one or more next-level materials in the fourth group, the method may further include: updating an available inventory amount of a corresponding next-level materials in the fourth group using the remaining amount of one or more next-level materials in the fourth group.

In an exemplary implementation mode, the calculating the maximum consumption amounts of the plurality of next-level materials with respect to at least one of the one or more materials with shortage includes: calculating a maximum consumption amount of one or more next-level materials in the third group with respect to one or more materials with shortage in the second group using a third linear programming model.

In act 13, the determining whether there is shortage in the one or more materials with shortage according to a maximum consumption amount and an available inventory amount of a corresponding material of the plurality of next-level materials may include: using an available inventory amount of one or more next-level materials in the third group to subtract a maximum consumption amount of the one or more next-level materials in the third group to obtain a remaining amount of the one or more next-level materials in the third group; when the remaining amount of the one or more next-level materials in the third group is less than 0, determining that there is shortage in one or more next-level materials in the third group.

In an exemplary implementation mode, a third objective function of the third linear programming model is expressed as follows.

$$obj 3 = max {\sum }_{i = 1}^{N} {d}_{i} * {x}_{i} .$$

Herein, xᵢ represents a satisfiable amount of a corresponding next-level material in the third group for preparation of a corresponding material with shortage in the second group; dᵢ represents a value of unit consumption of a corresponding next-level material in the third group with respect to one or more corresponding materials with shortage in the second group; N is a positive integer, N≥1.

In an exemplary implementation mode, the third objective function is constrained by a first constraint function, and the first constraint function is expressed as follows.

$${\sum }_{{x}_{i} ∈ ( {Q}_{l} , {G}_{j} )} {x}_{i} \leq {Q}_{l} .$$

Herein, Qₗ represents a shortage amount of an l-th material with shortage in the second group; (Qₗ, Gⱼ) represents a set of variables (which may be a collection of variables) of a j-th group of next-level materials with respect to the l-th material with shortage, and a plurality of next-level materials in the j-th group may be substituted for each other in production of the l-th material with shortage; 0≤xᵢ≤Qₗ; 1≤j≤J, wherein J represents a total number of groups of next-level materials that may be substituted for each other in production of the l-th material with shortage.

In an exemplary implementation mode, the third objective function is constrained by a second constraint function, and the second constraint function is expressed as follows.

$${\sum }_{{x}_{i} ∈ {X}_{m}} {d}_{i} * {x}_{i} \leq {C}_{m} .$$

Herein, Cₘ represents an available inventory amount of an m-th type of next-level material in the third group; Xₘ represents a set of variables (which may be a collection of variables) of an m-th next-level material; 1≤m≤M, wherein M represents a total number of types of next-level materials in the third group.

In an exemplary implementation mode, the data of the plurality of materials includes information on substitution relationships among the plurality of materials and a demanded amount for one or more product components.

In act 11, before acquiring the data of the plurality of next-level materials of the one or more materials with shortage for manufacturing the one or more product components, the method may further include: discriminating one or more materials in the first group from the plurality of materials according to the information on the substitution relationships among the plurality of materials, wherein the one or more materials in the first group are substitutable materials with respect to at least one of the one or more product components.

In act 02, the calculating the maximum consumption amounts of the plurality of materials with respect to at least one of the one or more product components may include: calculating a maximum consumption amount of the one or more materials in the first group with respect to the one or more product components according to data of the one or more materials in the first group.

In act 03, the determining whether there is shortage in one or more materials for manufacturing the one or more product components according to a maximum consumption amount of a corresponding material of the plurality of materials and an available inventory amount of the corresponding material of the plurality of materials may include: acquiring a satisfiable amount of one or more substitutable material groups in the first group with respect to the one or more product components when a consumption amount of one or more materials in the first group with respect to the one or more product components is a maximum consumption amount, and determining whether there is shortage in the one or more substitutable material groups in the first group with respect to a corresponding product component according to a satisfiable amount of the one or more substitutable material groups in the first group with respect to the corresponding product component and a demanded amount for the one or more product components in the first group.

In an exemplary implementation mode, the above determining whether there is a next-level material for a material with shortage when it is determined that there is shortage in the plurality of materials for manufacturing the one or more product components may include: determining whether there is a next-level material for a material group with shortage in the first group when it is determined that there is shortage in one or more substitutable material groups in the first group with respect to a corresponding product component.

The above acquiring data of the plurality of next-level materials of one or more materials with shortage for manufacturing the one or more product components when it is determined that there is a next-level material for the material with shortage may include: acquiring material data of one or more next-level materials of one or more material groups with shortage in the first group when it is determined that there is a next-level material for a material group with shortage in the first group.

In an exemplary implementation mode, in act 12, the calculating the maximum consumption amounts of the plurality of next-level materials with respect to at least one of the one or more materials with shortage may include: taking a plurality of next-level materials of one or more material groups with shortage in the first group as one or more next-level materials in a fifth group, calculating a maximum consumption amount of one or more next-level materials in the fifth group with respect to a product component corresponding to one or more material groups with shortage in the first group according to material data of the one or more next-level materials in the fifth group.

In act 13, the determining whether there is shortage in the one or more materials with shortage according to a maximum consumption amount and an available inventory amount of a corresponding material of the plurality of next-level materials may include: calculating a remaining amount of one or more next-level materials in the fifth group according to an available inventory amount of one or more next-level materials in the fifth group and a maximum consumption amount of one or more next-level materials in the fifth group with respect to a product component corresponding to one or more corresponding material groups with shortage in the first group, and determining whether there is shortage in the one or more next-level materials in the fifth group according to the remaining amount of the one or more next-level materials in the fifth group.

In an exemplary implementation mode, when it is determined above that there is shortage in one or more substitutable material groups in the first group with respect to a corresponding product component, the method may further include: calculating a shortage amount of one or more substitutable material groups in the first group with respect to a corresponding product component according to a satisfiable amount of one or more substitutable material groups in the first group with respect to the corresponding product component and a demanded amount of a material with shortage in the first group; when it is determined that there is shortage in the one or more next-level materials in the fifth group, the method may further include: calculating a sixth shortage value according to a satisfiable amount of one or more next-level materials in the fifth group for preparation of a corresponding material with shortage in the first group and a shortage amount of a corresponding material group with shortage in the first group, and updating the shortage amount of the corresponding material group with shortage in the first group using the sixth shortage value; acquiring a configuration parameter, reallocating a shortage amount of a material with shortage in the corresponding material group with shortage in the first group according to the configuration parameter, and updating a shortage amount of a corresponding material in the first group using the reallocated shortage amount.

In an exemplary implementation mode, the method may further include: when it is determined that there is shortage in the one or more next-level materials in the fifth group, acquiring a configuration parameter of a next-level material, reallocating a shortage amount of a corresponding next-level material with shortage in the fifth group according to the configuration parameter of the next-level material, and updating the shortage amount of the corresponding next-level material in the fifth group using the reallocated shortage amount.

In an exemplary implementation mode, the method may further include: adjusting a demand for the one or more product components to minimize overstock or shortage of the next-level materials when it is determined that there is overstock or shortage in the one or more materials with shortage according to a maximum consumption amount and an available inventory amount of a corresponding material of the plurality of next-level materials; and producing the one or more product components based on an adjusted demand for the one or more product components.

In an exemplary implementation mode, the method may further include: generating one or more user interfaces; herein, the one or more user interfaces include a first output interface configured to display a material state of a corresponding material in at least one of the first group to the fifth group.

In an exemplary implementation mode, the one or more user interfaces may further include a first input interface configured to receive one or more user inputs for querying a database; wherein data of the plurality of materials is stored in the database; herein, the computer-implemented method further includes: receiving, from the first input interface, user selection of one or more conditions, wherein the user selection is for selecting a material state associated with the one or more conditions; and in response to the user selection, querying the database to determine one or more material states in the database associated with the one or more conditions.

The one or more conditions may include at least one of an overstock state of an overstocked material and a shortage state of a material with shortage.

The one or more user interfaces may further include a second output interface configured to display one or more overstocked materials or materials with shortage as a result of querying the database.

In an exemplary implementation mode, the one or more user interfaces may further include a second input interface configured to receive one or more user inputs for adjusting a priority of a corresponding material in the first group; herein, the computer-implemented method may further include: re-determining whether a corresponding material in the first group is overstocked or short based on an adjusted priority of the corresponding material in the first group.

In an exemplary implementation mode, the one or more user interfaces may further include a third input interface configured to receive one or more user inputs for adjusting a demand for the one or more product components; herein, the computer-implemented method may further include: calculating an adjusted maximum consumption amount of a corresponding material in the first group based on the adjusted demand for the one or more product components; comparing the adjusted maximum consumption amount of the corresponding material in the first group with an available inventory amount of the corresponding material in the first group; and re-determining whether there is overstock or shortage in the corresponding material in the first group.

In an exemplary implementation mode, the computer-implemented method may further include: adjusting a demand for the one or more product components to minimize overstock or shortage in the next-level materials when it is determined that there is overstock or shortage in the one or more materials with shortage according to a maximum consumption amount and an available inventory amount of a corresponding material of the plurality of next-level materials; and producing the one or more product components based on the adjusted demand for the one or more product components. By adjusting the demand for one or more product components, it is possible to reduce materials for preparing the product components, as well as a shortage amount or overstock amount of the next-level materials of the materials for preparing the product components.

In an exemplary implementation mode, when a maximum consumption amount of a corresponding material of the plurality of next-level materials is greater than an available inventory amount, it is determined that the one or more materials with shortage still have shortage after the next-level materials are used to supplement shortage; when the maximum consumption amount of the corresponding material of the plurality of next-level materials is equal to the available inventory amount, it is determined that the one or more materials with shortage just meet a demand of product components after the next-level materials are used to supplement shortage; when the maximum consumption amount of the corresponding material of the plurality of next-level materials is less than the available inventory amount, it is determined that there is overstock in the one or more materials with shortage after the next-level materials are used to supplement shortage.

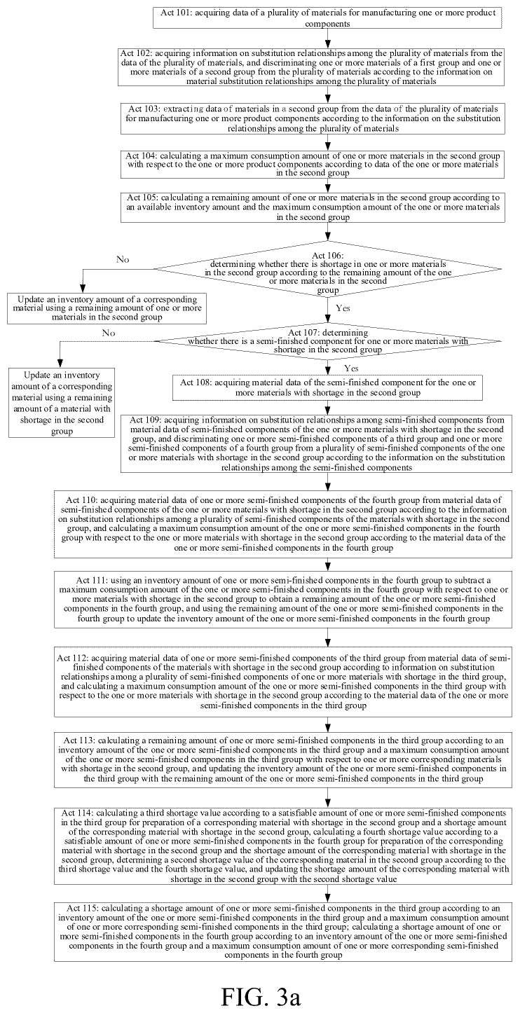

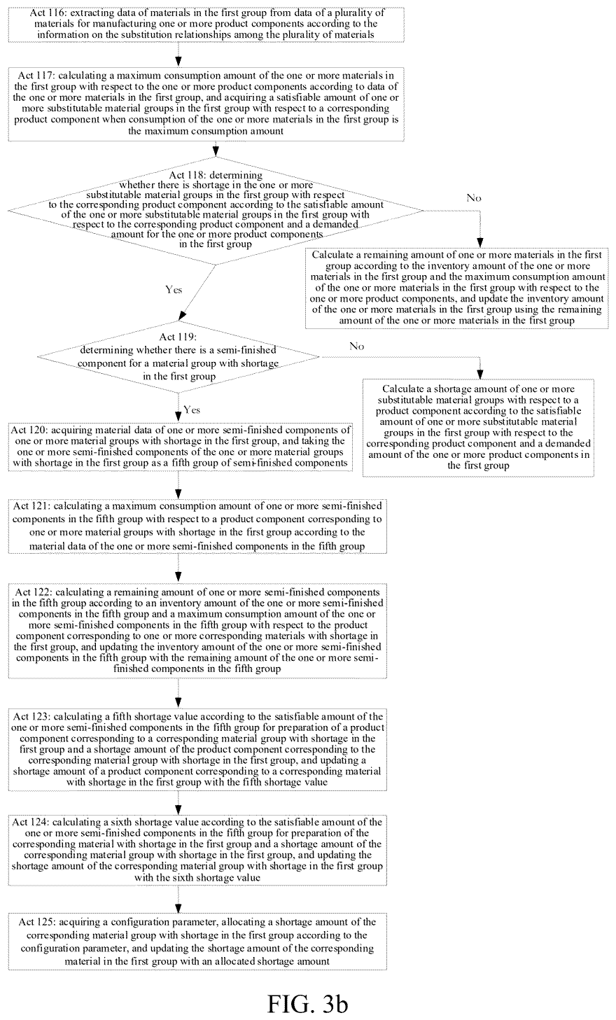

The following is exemplary description of a computer-implemented method according to an embodiment of the present disclosure, and a computer-implemented method according to an embodiment of the present disclosure may be applied to material management in a product production process. In an exemplary implementation mode, as shown in FIGS. 3a and 3b, a computer-implemented method according to an embodiment of the present disclosure may include acts 101 to 125.

Act 101: acquiring data of a plurality of materials for manufacturing one or more product components.

In an exemplary implementation mode, prior to manufacturing (or producing) one or more product components, data of all materials for manufacturing one or more product components may be input to a storage device. For example, the data of all materials may be input to the storage device in a scanning manner through a scanning device connected with a memory, or the data of all materials may be input to the storage device manually by a user, or a part of material data may be input to the storage device manually by the user, and a part of the material data may be input to the storage device in a scanning manner through the scanning device. In an embodiment of the present disclosure, data of a plurality of materials input to the storage device may be displayed through a graphical user interface.

In an exemplary implementation mode, act 101 may include: a processor acquires material data for manufacturing one or more product components from the storage device.

In an exemplary implementation mode, the material data for manufacturing one or more product components may include at least two of following: a product number of a product component, a demanded amount for the product component, a material number of a material required to prepare the product component, unit consumption of the material with respect to the product component, a substitution group of the material, a priority of the material, and an inventory amount of the material. As shown in Table 1 below, data of a plurality of materials for manufacturing one or more product components are as follows.

TABLE 1

| | | Unit | | | | |
|---|---|---|---|---|---|---|
| | | consumption of | | | | Demanded |
| | | a material by a | | Priority | Inventory | amount for |
| Product | Material | product | Substitution | of a | amount of a | a product |
| number | number | component | group | material | material | component |
| PRO-1 | A | 1 | D1 | 1 | 5000 | 20000 |
| PRO-1 | B | 1 | D1 | 2 | 2000 | 20000 |
| PRO-1 | C | 2 | D2 | 1 | 3000 | 20000 |
| PRO-1 | D | 2 | D2 | 2 | 1000 | 20000 |
| PRO-1 | E | 4 | Null value | 0 | 2500 | 20000 |
| PRO-2 | A | 2 | Null value | 0 | 5000 | 3000 |
| PRO-2 | F | 2 | Null value | 0 | 2000 | 3000 |
| PRO-3 | G | 3 | Null value | 0 | 2000 | 1000 |
| PRO-4 | C | 2 | D3 | 2 | 3000 | 1300 |
| PRO-4 | H | 2 | D3 | 1 | 1000 | 1300 |

In an exemplary implementation mode, as shown in Table 1, the data of the plurality of materials for manufacturing one or more product components may include: a list of product components represented by product numbers (e.g., PRO-1, PRO-2, PRO-3, and PRO-4), a list of materials required to prepare the product components represented by material numbers (e.g., A, B, C, D, E, F, G, and H). In an exemplary implementation mode, the data of the plurality of materials may further include unit consumption of the plurality of materials with respect to one or more product components, and a same material may have different unit consumption with respect to different product components. For example, for both product components with a product number PRO-1 and a product number PRO-2, a material A may be used as an ingredient in production (the ingredient in production may be understood as a material for preparing a product component), unit consumption of the material A with respect to a product component with the product number PRO-1 is 1, and unit consumption of the material A with respect to a product component with the product number PRO-2 is 2. In an exemplary implementation mode, the unit consumption may be a ratio of an amount of a material (calculated by weight or moles or pieces) required to be consumed to produce a certain amount of product components to an amount of product components.

In an exemplary implementation mode, the data of the plurality of materials may further include information on substitution relationships among the plurality of materials, and the information on the substitution relationships may include a substitution group identifier and a priority. The unit consumption of materials by product components in Table 1 may be understood as unit consumption of materials with respect to product components.

In an exemplary implementation mode, a same substitution group includes materials that may be substituted for each other in production of a same product component, and materials in the same substitution group have a same substitution group identifier (e.g., a material A and a material B used to produce a product component with the product number PRO-1 have a same substitution group identifier D1). For example, in preparation (i.e., production) of a product component with the product number PRO-1, the material A and the material B may be substituted for each other, and the material A and the material B are in a same substitution group D1. In production of the product component with the product number PRO-1, a material C and a material D may be substituted for each other, and the material C and the material D are in a same substitution group D2. The product component with the product number PRO-1 may be produced through four different material combinations including (A, D, E), (A, C, E), (B, D, E), and (B, C, E).

In an exemplary implementation mode, a same substitution group may include a plurality of materials with different priorities, for example, a first material and a second material may be included in the same substitution group, a priority of the first material may be higher than that of the second material, and the first material may be preferentially used over the second material having a lower priority in the same substitution group in production of a corresponding product. For example, in production of a product component with the product number PRO-1, a priority of the material A is 1 and a priority of material B is 2, then the material A is used as the first material, the material B is used as the second material, and the material A is used preferentially over the material B. In Table 1, a smaller number of a priority indicates a higher priority in the same substitution group.

In an exemplary implementation mode, as shown in Table 1, the data of the plurality of materials used to manufacture one or more products may further include an inventory amount for each of the plurality of materials, and a demanded amount for the plurality of product components. The demand for each of the plurality of product components may be listed in stages, such as by month, or a demanded amount in a current stage for each of the plurality of product components may be listed. For example, a demanded amount of a product component with the product number PRO-1 is 20,000, a demanded amount of a product component with a product number PRO-2 is 3,000, a demanded amount of a product component with a product number PRO-3 is 1,000, and a demanded amount of a product component with a product number PRO-4 is 1,300, an inventory amount of the material A is 5,000, an inventory amount of the material B is 2,000, an inventory amount of the material C is 3,000, and an inventory amount of the material D is 1,000.

Act 102: acquiring information on substitution relationships among the plurality of materials from the data of the plurality of materials, and discriminating one or more materials of the first group and one or more materials of the second group from the plurality of materials according to information on material substitution relationships among the plurality of materials.

In an exemplary implementation mode, the discriminating one or more materials of the first group and one or more materials of the second group from the plurality of materials according to the information on material substitution relationships among the plurality of materials may include: acquiring substitution group identifiers of the plurality of materials from the information on material substitution relationships among the plurality of materials, and discriminating the one or more materials of the first group and the one or more materials of the second group from the plurality of materials according to the substitution group identifiers of the plurality of materials. In an exemplary implementation mode, the one or more materials in the first group are substitutable materials with respect to at least one of the one or more product components, and the one or more materials in the second group are non-substitutable materials with respect to at least one of the one or more product components.

In an exemplary implementation mode, a material that may be discriminated as a material in the first group with respect to a particular product is represented by a non-null value in the “Substitution group” column, i.e., a substitution group identifier of the material in the first group is not null. In an exemplary implementation mode, as shown in Table 1, the non-null value of the substitution group identifier may be denoted as Dn, wherein n represents a substitution group number, and the non-null value of the substitution group identifier may include substitution group number 1 (“D1”), substitution group number 2 (“D2”), and substitution group number 3 (“D3”). Substitution group number 1 (“D1”) includes materials A and B with respect to a product PRO-1. Substitution group number 2 (“D2”) includes materials C and D with respect to the product PRO-1. Substitution group number 3 (“D3”) includes materials C and H with respect to a product PRO-4. As shown in Table 4, materials A, B, C, D, and H may be determined as materials in the first group, wherein each of the materials A, B, C, D, and H may be substitutable with respect to at least one of one or more products. For example, the material A may be substituted by the material B with respect to the product PRO-1; the material C may be substituted by the material D with respect to a product PRO-2; the material C may be substituted by a material H with respect to the product PRO-4.

In an exemplary implementation mode, a material that may be discriminated as a material in the second group with respect to a particular product is represented by a “null value” in the “Substitution group” column, i.e., a substitution group identifier of the material in the second group is a null value. As shown in Table 4, materials A, E, F, and G may be discriminated as materials in the second group, wherein each of the materials A, E, F, and G is non-substitutable with respect to at least one of one or more products. For example, the material A is non-substitutable with respect to the product PRO-2; a material E is non-substitutable with respect to the product PRO-1; a material F is non-substitutable with respect to the product PRO-2; a material G is non-substitutable with respect to a product PRO-3.

In an exemplary implementation mode, a same material may be in the first group with respect to one of product components, but in the second group with respect to another product component. Thus, the first group and the second group may have an intersection. For example, the material A is in the first group with respect to the product PRO-1, but in the second group with respect to the product PRO-2.

In an exemplary implementation mode, referring to Table 4, each material in the second group may be assigned a “null” value for a substitution group (i.e., a substitution group identifier of a material in the second group is set to a null value) and may be assigned a “0” value for a priority.

Act 103: extracting data of a material in the second group from the data of the plurality of materials for manufacturing one or more product components according to the information on the substitution relationships among the plurality of materials.

In an exemplary implementation mode, data of a material in the second group (i.e., data of an essential material or data of a non-substitutable material) is extracted from the data of the plurality of materials for manufacturing one or more product components of Table 1, as shown in Table 2.

TABLE 2

| | | Unit | | | | |
|---|---|---|---|---|---|---|
| | | consumption of | | | | Demanded |
| | | a material by a | | | Inventory | amount for |
| Product | Material | product | Substitution | | amount of | a product |
| number | number | component | group | Priority | a material | component |
| PRO-1 | E | 4 | Null value | 0 | 2500 | 20000 |
| PRO-2 | A | 2 | Null value | 0 | 5000 | 3000 |
| PRO-2 | F | 2 | Null value | 0 | 2000 | 3000 |
| PRO-3 | G | 3 | Null value | 0 | 2000 | 1000 |

In an exemplary implementation mode, the extracting the data of the materials in the second group from the data of the plurality of materials for manufacturing the one or more product components according to the information on the substitution relationships among the plurality of materials includes: extracting data of a material for which a field value of the substitution group is a null value.

Act 104: calculating a maximum consumption amount of the one or more materials in the second group with respect to the one or more product components according to data of the one or more materials in the second group.

In an exemplary implementation mode, act 104 may include using a sum of, a demanded amount for one or more product components requiring one or more materials in the second group as non-substitutable materials multiplied by values of corresponding unit consumption of corresponding materials in the second group with respect to manufacturing the one or more product components respectively, to obtain a maximum consumption amount of the one or more materials in the second group with respect to the one or more product components.

In an exemplary implementation mode, the maximum consumption amount of the one or more materials in the second group with respect to the one or more product components may be understood as a theoretical consumption amount of the one or more materials in the second group with respect to the one or more product components.

In an exemplary implementation mode, a maximum consumption amount of one of materials in the second group may be obtained by calculating a sum of consumption amounts of the one material with respect to all product components in the second group. As shown in Table 2, a consumption amount of a material E with respect to the product PRO-1 is equal to a demanded amount 20,000 for the product PRO-1 multiplied by unit consumption 4 of the material E with respect to the product PRO-1, to obtain a consumption amount of the material E with respect to the product PRO-1, which is equal to 20,000*4. The product PRO-2 and the product PRO-3 in the second group have no consumption for the material E, that is, consumption amounts of the material E with respect to the product PRO-2 and the product PRO-3 in the second group are 0. Therefore, a maximum consumption amount of the material E is a sum of consumption amounts of the material E with respect to the product PRO-1, the product PRO-2, and the product PRO-3, 20,000*4+0+0=80,000. By analogy, a maximum consumption amount of the material A in the second group is 0+3,000*2+0=6,000, a maximum consumption amount of the material F in the second group is 0+3,000*2+0=6,000, and a maximum consumption amount of the material G in the second group is 0+0+1,000*3=3,000.

Act 105: calculating a remaining amount of one or more materials in the second group according to an available inventory amount and a maximum consumption amount of the one or more materials in the second group.

In an exemplary implementation mode, act 105 may include using the available inventory amount of the one or more materials in the second group to subtract a maximum consumption amount of a corresponding material to obtain the remaining amount of the one or more materials in the second group.

In an exemplary implementation mode, if the remaining amount of one or more materials in the second group is greater than 0, it means that there is surplus of the materials after meeting product production requirements; if the remaining amount of one or more materials in the second group is equal to 0, it means that the materials are just enough to meet the product production requirements; and if the remaining amount of one or more materials in the second group is less than 0, it means that the materials cannot meet the product production requirements, that is, there is shortage in the materials.

In an exemplary implementation mode, the available inventory amount of one or more materials in the second group may be an inventory amount of a material in Table 2. As shown in Table 2, a maximum consumption amount of the material E is 20,000*4, and an inventory amount of the material E is 2,500, the inventory amount 2,500 of the material E is used to subtract the maximum consumption amount 20,000*4 of the material E to obtain a remaining amount of the material E in the second group: 2,500−20,000*4=−77,500. By analogy, a remaining amount of the material A is 5,000−3,000*2=−1,000, a remaining amount of the material F is 2,000−3,000*2=−4,000, and a remaining amount of the material G is 2,000−1,000*3=−1,000. Remaining amounts of materials A, E, F, and G in the second group in Table 2 are less than 0, indicating that there is shortage in materials A, E, F, and G, and shortage amounts are 1,000, 77,500, 4,000, and 1,000 respectively.

Act 106: determining whether there is shortage in one or more materials in the second group according to the remaining amount of the one or more materials in the second group, and if so, executing act 107, otherwise updating an inventory amount of a corresponding material in the second group using the remaining amount of the one or more materials in the second group.

In an exemplary implementation mode, as shown in Table 2, remaining amounts of materials A, E, F, and G are less than 0, it is determined that there is shortage in the materials A, E, F, and G in the second group.

In an exemplary implementation mode, the determining whether there is shortage in one or more materials in the second group according to the remaining amount of the one or more materials in the second group may include: acquiring a satisfiable amount of one or more materials in the second group with respect to the one or more product components when a consumption amount of the one or more materials in the second group with respect to the one or more product components is a maximum consumption amount, and determining whether there is shortage in the one or more materials in the second group with respect to a corresponding product component according to the satisfiable amount of the one or more materials in the second group with respect to the one or more product components and a demanded amount for the one or more product components.

Act 107: determining whether there is a semi-finished component for a material with shortage in the second group; if so, executing act 108; otherwise, updating an inventory amount of a corresponding material with shortage in the second group using a remaining amount of the material with shortage in the second group.

In an exemplary implementation mode, the semi-finished component may be a next-level material of a material with shortage.

In an exemplary implementation mode, as may be seen from Table 2, there is shortage in materials A, E, F, and G, wherein there is no semi-finished component for materials A and E, there are semi-finished components for materials F and G, then, shortage in materials A and E is used, and shortage amounts are 1,000 and 77,500 respectively. An inventory amount of the material A is updated using a remaining amount of the material A −1,000 (the inventory amount of the material A becomes −1,000 after updating), and an inventory amount of the material E is updated using a remaining amount of the material E −77,500 (the inventory amount of the material E becomes −77,500 after updating).

Act 108: acquiring material data of a semi-finished component of one or more materials with shortage in the second group.

In an exemplary implementation mode, the material data of the semi-finished component of the material with shortage in the second group may include: a material number of the material with shortage, a material number of the semi-finished component, unit consumption of the semi-finished component by a necessary material (that is, unit consumption of the semi-finished component with respect to the necessary material), a substitution group of the semi-finished component, an inventory amount of the semi-finished component, and a shortage amount of the material (which may be understood as a demanded amount that the semi-finished component needs to meet). The material data of the semi-finished component of the material with shortage in the second group may be shown in Table 3.

TABLE 3

| | | Unit | | | | | | |
|---|---|---|---|---|---|---|---|---|
| | | consumption | | | | | | |
| | | of a | | | | | | Material |
| | Material | semi-finished | Substitution | | Inventory | | | consumption |
| | number | component | group | Priority | amount | Shortage | | amount |
| | of a | by a | of a | of a | of a | amount | | of a |
| Material | semi-finished | necessary | semi-finished | semi-finished | semi-finished | of a | Satisfiable | semi-finished |
| number | component | material | component | component | component | material | amount | component |
| F | PCB-1 | 2 | D4 | 1 | 1000 | 4000 | x1 | 2 × 1 |
| F | PCB-2 | 2 | D4 | 2 | 1000 | 4000 | x2 | 2 × 2 |
| F | PCB-10 | 1 | Null | 0 | 1000 | 4000 | | |
| | | | value | | | | | |
| G | PCB-2 | 1 | D5 | 1 | 1000 | 1000 | x3 | x3 |
| G | PCB-5 | 1 | D5 | 2 | 300 | 1000 | x4 | x4 |

As shown in Table 3, a semi-finished component PCB-1 and a semi-finished component PCB-2 are located in a same substitution group D4, and the semi-finished component PCB-1 and the semi-finished component PCB-2 may be substituted for each other in preparation of the material F; the semi-finished component PCB-2 and a semi-finished component PCB-5 are located in a same substitution group D5, and the semi-finished component PCB-2 and the semi-finished component PCB-5 may be substituted for each other in preparation of the material G; a substitution group of a semi-finished component PCB-10 is null and a priority of the semi-finished component PCB-10 is 0. Therefore, the semi-finished component PCB-10 is a necessary material with respect to the material F; the semi-finished component PCB-2 may be used to prepare the material F and the material G, so the semi-finished component PCB-2 belongs to a common material for preparing the material F and the material G.

Act 109: acquiring information on substitution relationships among semi-finished components from material data of semi-finished components of one or more materials with shortage in the second group, and discriminating one or more semi-finished components of the third group and one or more semi-finished components of the fourth group from a plurality of semi-finished components of the one or more materials with shortage in the second group according to the information on the substitution relationships among the semi-finished components.

In an exemplary implementation mode, discriminating the one or more semi-finished components of the third group and the one or more semi-finished components of the fourth group from the plurality of semi-finished components of the materials with shortage in the second group according to the information on the substitution relationships among the semi-finished components may include: acquiring substitution group identifiers of the plurality of semi-finished components of the materials with shortage in the second group from information on material substitution relationships among the plurality of semi-finished components, and discriminating the one or more semi-finished components of the third group and the one or more semi-finished components of the fourth group from the plurality of semi-finished components according to the substitution group identifiers of the plurality of semi-finished components. In an exemplary implementation mode, the one or more semi-finished components in the third group are substitutable materials with respect to at least one of the one or more materials with shortage in the second group, and the one or more semi-finished components in the fourth group are non-substitutable materials with respect to at least one of the one or more materials with shortage in the second group. As shown in Table 3, a substitution group of the semi-finished component PCB-10 is null and a priority of the semi-finished component PCB-10 is 0. In a process of preparation of the material F, the semi-finished component PCB-10 is a non-substitutable material, and the semi-finished component PCB-10 is determined to be a semi-finished component in the third group in the materials with shortage in the second group; a substitution group of the semi-finished component PCB-1 and the semi-finished component PCB-2 is D4, and a substitution group of the semi-finished component PCB-2 and the semi-finished component PCB-5 is D5. Therefore, the semi-finished component PCB-1, the semi-finished component PCB-2, and the semi-finished component PCB-5 are substitutable materials and are determined to be semi-finished components in the fourth group in the materials with shortage in the second group. For example, the semi-finished component PCB-1 and the semi-finished component PCB-2 are substitutable materials for preparation of the material F, and the semi-finished component PCB-2 and the semi-finished component PCB-5 are substitutable materials for preparation of the material G.

Act 110: acquiring material data of one or more semi-finished components of the fourth group from material data of semi-finished components of the one or more materials with shortage in the second group according to information on substitution relationships among a plurality of semi-finished components of the materials with shortage in the second group, and calculating a maximum consumption amount of the one or more semi-finished components in the fourth group with respect to the one or more materials with shortage in the second group according to the material data of the one or more semi-finished components in the fourth group.

In an exemplary implementation mode, the calculating the maximum consumption amount of the one or more semi-finished components in the fourth group with respect to the one or more materials with shortage in the second group according to the material data of the one or more semi-finished components in the fourth group may include: using a sum of, a shortage amount of the one or more materials with shortage in the second group requiring one or more semi-finished components in the fourth group as non-substitutable materials respectively, multiplied by values of unit consumption of corresponding semi-finished components in the fourth group with respect to manufacturing one or more corresponding materials with shortage in the second group, to obtain a maximum consumption amount of one or more product components in the fourth group with respect to one or more materials with shortage in the second group.

As shown in Table 3, material data of the semi-finished component PCB-10 of materials with shortage in the second group is acquired from material data of a plurality of semi-finished components of materials with shortage in the second group, including a shortage amount of the material F with shortage in the second group requiring the semi-finished component PCB-10 as a non-substitutable material, unit consumption of the semi-finished component PCB-10 with respect to the material F with shortage in the second group, and an inventory amount of the semi-finished component PCB-10. A consumption amount 4,000 of the semi-finished component PCB-10 with respect to the material F with shortage in the second group is obtained by multiplying a shortage amount 4,000 of the material F with shortage in the second group requiring the semi-finished component PCB-10 as a non-substitutable material by a value, 1, of the unit consumption of the semi-finished component PCB-10 with respect to the material F with shortage in the second group. Since the material F does not have a shared relationship with other materials for the semi-finished component PCB-10 in Table 3, a maximum consumption amount of the semi-finished component PCB-10 of the material with shortage in the second group is 4,000.

Act 111: using an inventory amount of the one or more semi-finished components in the fourth group to subtract a maximum consumption amount of the one or more semi-finished components in the fourth group with respect to one or more materials with shortage in the second group to obtain a remaining amount of the one or more semi-finished components in the fourth group, and using the remaining amount of the one or more semi-finished components in the fourth group to update the inventory amount of the one or more semi-finished components in the fourth group.

In an exemplary implementation mode, as shown in Table 3, an inventory amount 1,000 of the semi-finished component PCB-10 in the fourth group is used to subtract a maximum consumption amount 4,000 of the semi-finished component PCB-10 in the fourth group with respect to the material F with shortage in the second group to obtain a remaining amount −3,000 of the semi-finished component PCB-10 in the fourth group. In the embodiment of the present disclosure, if a remaining amount of a semi-finished component in the fourth group is greater than 0, it means that the semi-finished component has a remaining amount after replenishing a shortage amount of a material with shortage in the second group. If the remaining amount of the semi-finished component in the fourth group is equal to 0, it means that the semi-finished component is just able to replenish the shortage amount of the material with shortage in the second group; If the remaining amount of the semi-finished component in the fourth group is less than 0, it means that the semi-finished component is just not able to replenish the shortage amount of the material with shortage in the second group. If the remaining amount −3,000 of the semi-finished component PCB-10 in the fourth group is less than 0, it means that there is shortage in the semi-finished component PCB-10, and a shortage amount is 3,000.

In an exemplary implementation mode, one or more materials with shortage in the second group may be converted to an inventory amount of a corresponding semi-finished component in the fourth group, and when the inventory amount of the corresponding semi-finished component in the fourth group is greater than or equal to 0, it means that there is no shortage in the semi-finished component, and the corresponding material with shortage in the second group may be replenished. When the inventory amount of the corresponding semi-finished component in the fourth group is less than 0, it means that there is shortage in the semi-finished component, and the corresponding material with shortage in the second group cannot be replenished.

In an exemplary implementation mode, when a plurality of materials with shortage in the second group share one semi-finished component in the fourth group, a remaining amount of the semi-finished component may be obtained by using an inventory amount of the semi-finished component to subtract a sum of maximum consumption amounts of the semi-finished component by the materials sharing the semi-finished component.

In an exemplary implementation mode, act 111 may further include determining that there is shortage in one or more materials in the fourth group when the remaining amount of the one or more next-level materials in the fourth group is less than 0. In an exemplary implementation mode, when it is determined that there is shortage in one or more materials in the fourth group, the method may further include: displaying a shortage state and a shortage amount of the one or more materials in the fourth group through the first output interface. In an exemplary implementation mode, the shortage amount may be a negative of the remaining amount, at this time, when the shortage amount is positive, it means that there is shortage; or the shortage amount may be equal to the remaining amount, at this time, when the shortage amount is negative, it means that there is shortage.

In an exemplary implementation mode, act 111 may further include: when the remaining amount of the one or more next-level materials in the fourth group is greater than 0, determining whether the one or more next-level materials in the fourth group are substitutable materials with respect to at least one of one or more materials with shortage in the first group according to the information on the substitution relationships among the next-level materials, and determining that there is overstock in the one or more next-level materials in the fourth group when it is determined that the one or more next-level materials in the fourth group are not substitutable materials with respect to the one or more materials with shortage in the first group. In an exemplary implementation mode, when it is determined that there is overstock in the one or more next-level materials in the fourth group, the method may further include: displaying an overstock state and a remaining amount of the one or more next-level materials in the fourth group through the first output interface.

Act 112: acquiring material data of the one or more semi-finished components of the third group from material data of semi-finished components of material with shortage in the second group according to information on substitution relationships among a plurality of semi-finished components of one or more materials with shortage in the third group, and calculating a maximum consumption amount of the one or more semi-finished components in the third group with respect to the one or more materials with shortage in the second group according to the material data of the one or more semi-finished components in the third group.

In an exemplary implementation mode, the calculating the maximum consumption amount of the one or more semi-finished components in the third group with respect to the one or more materials with shortage in the second group according to the material data of the one or more semi-finished components in the third group may include: calculating a maximum consumption amount of the one or more semi-finished components in the third group with respect to the one or more materials with shortage in the second group using a third linear programming model.

In an exemplary implementation mode, a third objective function of the third linear programming model is expressed as follows.

$$obj 3 = max {\sum }_{i = 1}^{N} {d}_{i} * {x}_{i} .$$

Herein, xᵢ represents an amount of a corresponding material with shortage in the second group that can be produced using a corresponding semi-finished component in the third group (i.e., a satisfiable amount of one or more semi-finished components in the third group for preparation of the corresponding material with shortage in the second group); dᵢ represents a value of unit consumption of a corresponding semi-finished component in the third group with respect to one or more corresponding materials with shortage in the second group; N is a positive integer representing a total number of corresponding semi-finished components in the third group, N≥1.

In an exemplary implementation mode, the third objective function is used to calculate a sum of maximum consumption amounts of one or more semi-finished components in the third group, and as shown in Table 3, satisfiable amounts of one or more semi-finished components in the third group for preparation of a corresponding material with shortage in the second group are respectively set as follows: a satisfiable amount of the semi-finished component PCB-1 for preparation of the material F is set to x1, a satisfiable amount of the semi-finished component PCB-2 for preparation of the material F is set to x2, a satisfiable amount of the semi-finished component PCB-2 for preparation of the material G is set to x3, and a satisfiable amount of the semi-finished component PCB-5 for preparation of the material G is set to x4; a value of unit consumption of the semi-finished component PCB-1 with respect to the material F is 2, a value of unit consumption of the semi-finished component PCB-2 with respect to the material F is 2, a value of unit consumption of the semi-finished component PCB-2 with respect to the material G is 1, and a value of unit consumption of the semi-finished component PCB-5 with respect to the material G is 1; maximum consumption amounts of one or more semi-finished components in the third group are calculated using a linear programming model as follows respectively: a maximum consumption amount of the semi-finished component PCB-1 with respect to the material F is 2*x1, a maximum consumption amount of the semi-finished component PCB-2 with respect to the material F is 2*x2, a maximum consumption amount of the semi-finished component PCB-2 with respect to the material G is 1*x3, and a maximum consumption amount of the semi-finished component PCB-5 with respect to the material G is 1*x4; the sum of the maximum consumption amounts of one or more semi-finished components in the third group is:

$$Max 3 = 2 x 1 + 2 x 2 + x 3 + x 4.$$

In an exemplary implementation mode, the third objective function is constrained by a first constraint function, and the first constraint function is expressed as follows.

$${\sum }_{{x}_{i} ∈ ( {Q}_{l} , {G}_{j} )} {x}_{i} \leq {Q}_{l} .$$

Herein, Qₗ represents a shortage amount (i.e., a demanded amount) of an l-th material with shortage in the second group; (Qₗ, Gⱼ) represents a set of variables (which may be a collection of variables) of a j-th group of semi-finished components with respect to the l-th material with shortage, and a plurality of semi-finished components in the j-th group may be substituted for each other in production of the l-th material with shortage, 0≤xᵢ≤Qₗ; 1≤j≤J, wherein J represents a total number of groups of semi-finished components that may be substituted for each other in production of the l-th material with shortage.

In an exemplary implementation mode, the first constraint function of the third objective function may be understood as a constraint on a shortage amount of a corresponding material with shortage in the second group (i.e., a demanded amount of the corresponding material with shortage in the second group). According to Table 3, there is shortage in the material F and the material G (i.e., a value of l is 2), a shortage amount Q₁ of the material F is 4,000, a shortage amount Q₂ of the material G is 1,000, a total number J of a group of semi-finished components that may be substituted with each other in preparation of the material F is 1 (the group of semi-finished components includes: the semi-finished component PCB-1 and the semi-finished component PCB-2), a total number J of a group of two semi-finished components that may be substituted with each other in preparation of the material G is 1 (the group of semi-finished components includes: the semi-finished component PCB-2 and the semi-finished component PCB-5), and a constraint on a shortage amount of a corresponding material with shortage in the second group is as follows.

A constraint on the material F with shortage in the second group is: x1+x2≤4000.

A constraint on the material G with shortage in the second group is: x3+x4≤1000.

In an exemplary implementation mode, the third objective function may also be constrained by a second constraint function, and the second constraint function is expressed as follows.

$${\sum }_{{x}_{i} ∈ {X}_{m}} {d}_{i} * {x}_{i} \leq {C}_{m} .$$

Herein, Cₘ represents an available inventory amount of an m-th type of next-level material in the third group; Xₘ represents a set of variables (which may be a collection of variables) of an m-th next-level material; 1≤m≤M, wherein M represents a total number of types of next-level materials in the third group.

In an exemplary implementation mode, the second constraint function of the third objective function may be understood as a constraint on an inventory amount of a corresponding semi-finished component in the third group, as shown in Table 3, a total number M of types of semi-finished components (including: the semi-finished component PCB-1, the semi-finished component PCB-2, and the semi-finished component PCB-5) in the third group is 3, an available inventory amount of the semi-finished component PCB-1 is 1,000, an available inventory amount of the semi-finished component PCB-2 is 1,000, an available inventory amount of the semi-finished component PCB-5 is 300, and a constraint on an inventory amount of a corresponding semi-finished component in the third group is as follows.

A constraint on an inventory amount of the semi-finished component PCB-1 is: 2x1≤1000.

A constraint on an inventory amount of the semi-finished component PCB-2 is: 2x2+x3≤1000.

A constraint on an inventory amount of the semi-finished component PCB-5 is: x4≤300.

In an exemplary implementation mode, the third linear programming model is used above to calculate the maximum consumption amount of one or more semi-finished components in the third group with respect to one or more materials with shortage in the second group, and on a premise that the first constraint function and the second constraint function are satisfied, values of x1, x2, x3, and x4 that enable a sum (Max3) of maximum consumption amounts of one or more semi-finished components in the third group to be maximized may be acquired, and an inventory amount of semi-finished components may be reduced as much as possible and a shortage amount of a material with shortage in the second group may be replenished as much as possible, so as to reduce overstock of semi-finished components and shortage of materials in the second group.

Act 113: calculating a remaining amount of one or more semi-finished components in the third group according to an inventory amount of the one or more semi-finished components in the third group and a maximum consumption amount of the one or more semi-finished components in the third group with respect to one or more corresponding materials with shortage in the second group, and updating the inventory amount of the one or more semi-finished components in the third group using the remaining amount of the one or more semi-finished components in the third group.

In an exemplary implementation mode, in act 113, the calculating the remaining amount of one or more semi-finished components in the third group according to the inventory amount of the one or more semi-finished components in the third group and the maximum consumption amount of the one or more semi-finished components in the third group with respect to one or more corresponding materials with shortage in the second group may include: using the inventory amount of the one or more semi-finished components in the third group to subtract the maximum consumption amount of the one or more semi-finished components in the third group with respect to the one or more corresponding materials with shortage in the second group to obtain the remaining amount of the one or more semi-finished components in the third group.

In an exemplary implementation mode, act 113 may further include: determining whether the remaining amount of the one or more semi-finished components in the third group is greater than or equal to 0, and if so, determining that one or more semi-finished components in the third group may replenish a shortage amount of one or more materials with shortage in the second group; otherwise, determining that one or more semi-finished components in the third group cannot replenish the shortage amount of the one or more materials with shortage in the second group.

Description is given by taking consumption of the semi-finished component PCB-1 and the semi-finished component PCB-2 for supplementing a shortage amount of the material F in Table 3 as an example, a priority of the semi-finished component PCB-1 is 1, a priority of the semi-finished component PCB-2 is 2, then the semi-finished component PCB-1 is preferentially used to supplement shortage of the material F, and an inventory amount 1,000 of the semi-finished component PCB-1 is used to subtract a maximum consumption amount 2x1 of the semi-finished component PCB-1 with respect to the material F with shortage, to obtain a remaining amount of the semi-finished component PCB-1, which is 1000−2x1. When 1000−2x1 is greater than or equal to 0, it means that the semi-finished component PCB-1 can replenish the shortage amount of the material F. At this time, shortage of the material F can be replenished without consuming the semi-finished component PCB-2. When 1000−2x1 is less than 0, it means that the semi-finished component PCB-1 cannot replenish the shortage amount of the material F, then the semi-finished component PCB-2 is used to supplement the shortage amount of the material F. A satisfiable amount (x2) of the semi-finished component PCB-2 for preparation of the material F is equal to the shortage amount (4,000) of the material F minus a satisfiable amount (x1) of the semi-finished component PCB-1 for preparation of the material F, and the inventory amount 1,000 of the semi-finished component PCB-2 is used to subtract a maximum consumption amount 2x2 of the semi-finished component PCB-2 with respect to the material F with shortage, to obtain a remaining amount of the semi-finished component PCB-2, which is 1000−2x2=1000−2 (4000−x1). If the remaining amount 1000−2x2 of the semi-finished component PCB-2 is greater than or equal to 0, it means that the semi-finished component PCB-1 and the semi-finished component PCB-2 may replenish the shortage amount of the material F, and there is no shortage in a semi-finished component in the third group for preparation of the material F. If the remaining amount 1000−2x2 of the semi-finished component PCB-2 is less than 0, it means that the semi-finished component PCB-2 and the semi-finished component PCB-1 cannot replenish the shortage amount of the material F, and there is shortage in a semi-finished component in the third group for preparation of the material F.

In an exemplary implementation mode, the inventory amount of the one or more semi-finished components in the third group is updated by using the remaining amount of the one or more semi-finished components in the third group, and whether there is shortage in a corresponding semi-finished component in the third group in preparation of a corresponding material with shortage in the second group may be determined through the updated inventory amount, if the updated inventory amount is greater than or equal to 0, it indicates that there is no shortage in the corresponding semi-finished component in the third group, and if the updated inventory amount is less than 0, it indicates that there is shortage in the corresponding semi-finished component in the third group, the inventory amount is negative when there is shortage, and an absolute value of the inventory amount is a shortage amount.

In an exemplary implementation mode, description is given by taking a case in which the semi-finished component PCB-1 is consumed in preparation of the material F as an example, a remaining amount of the semi-finished component PCB-1 is 1000−2x1 after the semi-finished component PCB-1 is used to replenish the shortage amount of the material F, and the inventory amount of the semi-finished component PCB-1 may be updated from 1000 to 1000−2x1, so as to avoid an inventory amount of a semi-finished component (PCB-1) being higher than an actual inventory amount, and thus materials of semi-finished components may be effectively managed.

Act 114: calculating a third shortage value according to a satisfiable amount of one or more semi-finished components in the third group for preparation of a corresponding material with shortage in the second group and the shortage amount of the corresponding material with shortage in the second group, calculating a fourth shortage value according to a satisfiable amount of one or more semi-finished components in the fourth group for preparation of the corresponding material with shortage in the second group and a shortage amount of the corresponding material with shortage in the second group, determining a second shortage value of the corresponding material in the second group according to the third shortage value and the fourth shortage value, and updating a shortage amount of the corresponding material with shortage in the second group using the second shortage value.

In an exemplary implementation mode, the calculating the third shortage value according to the satisfiable amount of one or more semi-finished components in the third group for the preparation of the corresponding material with shortage in the second group and the shortage amount of the corresponding material with shortage in the second group, and calculating the fourth shortage value according to the satisfiable amount of one or more semi-finished components in the fourth group for the preparation of the corresponding material with shortage in the second group and the shortage amount of the corresponding material with shortage in the second group may include: using the shortage amount of the corresponding material with shortage in the second group to subtract the satisfiable amount of one or more semi-finished components in the third group for the preparation of the corresponding material with shortage in the second group to obtain a third shortage value of the corresponding material in the second group; using the shortage amount of the corresponding material with shortage in the second group to subtract the satisfiable amount of one or more semi-finished components in the fourth group for the preparation of the corresponding material with shortage in the second group to obtain a fourth shortage value of the corresponding material in the second group.

Herein, the satisfiable amount of one or more semi-finished components in the third group for the preparation of the corresponding material with shortage in the second group is equal to integer data rounded down from a ratio between an inventory amount of the one or more semi-finished components in the third group and a value of unit consumption of one or more semi-finished components in the third group with respect to the corresponding material with shortage in the second group; the satisfiable amount of one or more semi-finished components in the fourth group for the preparation of the corresponding material with shortage in the second group is equal to integer data rounded down from a ratio between an inventory amount of the one or more semi-finished components in the fourth group and a value of unit consumption of one or more semi-finished components in the fourth group with respect to the corresponding material with shortage in the second group.

In an exemplary implementation mode, the determining the second shortage value of the corresponding material in the second group according to the third shortage value and the fourth shortage value may include: when the third shortage value and the fourth shortage value for a same material with shortage in the second group are the same, taking the third shortage value and the fourth shortage value as the second shortage value, and when the third shortage value and the fourth shortage value for a same material with shortage in the second group are different, taking a larger one of the third shortage value and the fourth shortage value as the second shortage value. As shown in Table 3, description is given by taking a case in which the material F is supplemented using the semi-finished component PCB-10 in the fourth group, the semi-finished component PCB-1 in the third group, and the semi-finished component PCB-2 in the third group as an example: a satisfiable amount of the semi-finished component PCB-10 for the preparation of the material F is equal to integer data rounded down from a ratio between an inventory amount 1,000 of the semi-finished component PCB-10 and a value 1 of unit consumption of the semi-finished component PCB-10 with respect to the material F (the integer data obtained by dividing 1,000 by 1 and rounding down is 1,000); that is, the satisfiable amount of the semi-finished component PCB-10 for the preparation of the material F is 1,000; a shortage amount 4,000 of the material F is used to subtract the satisfiable amount 1,000 of the semi-finished component PCB-10 for the preparation of the material F to obtain a fourth shortage value of the material F, which is 3,000. A satisfiable amount of the semi-finished component PCB-1 and the semi-finished component PCB-2 for the preparation of the material F is x1+x2, the shortage amount 1,000 of the material F is used to subtract the satisfiable amount x1+x2 of the semi-finished component PCB-1 and the semi-finished component PCB-1 for the preparation of the material F to obtain a third shortage value of the material F, which is 1000−(x1+x2). If the third shortage value 1000−(x1+x2) is equal to the fourth shortage value 3,000, the third shortage value and the fourth shortage value 3,000 are used as a second shortage value of the material F. If the third shortage value 1000−(x1+x2) is greater than the fourth shortage value 3,000, the third shortage value 1000−(x1+x2) is used as the second shortage value of the material F, and if the third shortage value 1000−(x1+x2) is smaller than the fourth shortage value 3,000, the fourth shortage value 3,000 is used as the second shortage value of the material F.

In an exemplary implementation mode, when the fourth shortage value is less than or equal to 0, it indicates that one or more semi-finished components in the fourth group may satisfy the corresponding material with shortage in the second group, and then there is no shortage in the one or more semi-finished components in the fourth group; when the fourth shortage value is greater than 0, it indicates that one or more semi-finished components in the fourth group cannot satisfy the corresponding material with shortage in the second group, and then there is shortage in one or more semi-finished components in the fourth group. In an exemplary implementation mode, restricted by the first constraint function, when a semi-finished component in the third group is used to supplement a material with shortage in the second group, a satisfiable amount of one or more semi-finished components in the third group for preparation of a corresponding material with shortage in the second group does not exceed a shortage amount of the corresponding material with shortage in the second group, for example, when the semi-finished component PCB-1 and the semi-finished component PCB-2 are used to supplement the material F, a satisfiable amount x1+x2 of the semi-finished component PCB-1 and the semi-finished component PCB-2 for the preparation of the material F does not exceed a shortage amount 1,000 of the material F with shortage, so that the third shortage value is usually not less than 0, when the third shortage value is greater than 0, it indicates that there is shortage in one or more semi-finished components in the third group, and when the third shortage value is equal to 0, it indicates that there is no shortage in one or more semi-finished components in the third group.

In an exemplary implementation mode, taking the larger one of the third shortage value and the fourth shortage value as the second shortage value of one or more materials with shortage in the second group may avoid that the larger one will still have a gap when the smaller one is used as a shortage value, resulting in an inability to meet actual shortage. Act 115: calculating a shortage amount of one or more semi-finished components in the third group according to an inventory amount of the one or more semi-finished components in the third group and a maximum consumption amount of one or more corresponding semi-finished components in the third group; calculating a shortage amount of one or more semi-finished components in the fourth group according to an inventory amount of one or more semi-finished components in the fourth group and a maximum consumption amount of one or more corresponding semi-finished components in the fourth group.

In an exemplary implementation mode, a shortage amount of one or more materials with shortage in the second group may be converted to a shortage amount of one or more semi-finished components in the third group and the fourth group.

In an exemplary implementation mode, since one or more semi-finished components in the fourth group are necessary materials for preparation of one or more corresponding materials with shortage in the second group, and there is no substitutable material, an inventory amounts of one or more semi-finished components in the fourth group may be used to subtract a maximum consumption amount of the one or more corresponding semi-finished components in the fourth group to obtain a shortage amount of the one or more semi-finished components in the fourth group.

In an exemplary implementation mode, since one or more semi-finished components in the third group are substitutable materials for preparation of one or more corresponding materials with shortage in the second group, a shortage amount in a same substitution group may be set according to a configuration parameter, and in an exemplary implementation mode, the configuration parameter may include one or more of priority, usage possibility, low cost of semi-finished components, and setting a shortage amount of a semi-finished component according to one or more of proportional allocation as parameters, thereby facilitating business strategy adjustment. For example, in a same substitution group, a semi-finished component having a higher priority (a lower priority value) may be preferentially used, or a semi-finished component having higher possibility of use may be preferentially selected and used, or a semi-finished component having a lower manufacturing cost may be preferentially used, or a shortage amount may be allocated to a plurality of semi-finished components in the same substitution group according to a proportion.

Act 116: extracting data of materials in the first group from data of a plurality of materials for manufacturing one or more product components according to the information on the substitution relationships among the plurality of materials.

In an exemplary implementation mode, data of materials in the first group (i.e., data of substitutable materials) is extracted from data of a plurality of materials for manufacturing one or more product components of Table 1, as shown in Table 4.

TABLE 4

| | | Unit | | | | | | |
|---|---|---|---|---|---|---|---|---|
| | | consumption | | | | | | |
| | | of a | | | | Demanded | | |
| | | material | | | Inventory | amount | | |
| | | by a | | Priority | amount | for a | | Consumption |
| Product | Material | product | Substitution | of a | of a | product | Satisfiable | amount of |
| number | number | component | group | material | material | component | amount | a material |
| PRO-1 | A | 1 | D1 | 1 | 5000 | 20000 | y1 | y1 |
| PRO-1 | B | 1 | D1 | 2 | 2000 | 20000 | y2 | y2 |
| PRO-1 | C | 2 | D2 | 1 | 3000 | 20000 | y3 | 2y3 |
| PRO-1 | D | 2 | D2 | 2 | 1000 | 20000 | y4 | 2y4 |
| PRO-4 | C | 2 | D3 | 2 | 3000 | 1300 | y5 | 2y5 |
| PRO-4 | H | 2 | D3 | 1 | 1000 | 1300 | y6 | 2y6 |

In an exemplary implementation mode, the extracting data of materials in the first group from the data of the plurality of materials for manufacturing one or more product components according to the information on the substitution relationships among the plurality of materials may include: extracting data of a product component for which a field value in a substitution group is not a null value.

Act 117: calculating a maximum consumption amount of the one or more materials in the first group with respect to the one or more product components according to data of the one or more materials in the first group, and acquiring a satisfiable amount of one or more substitutable material groups in the first group with respect to a corresponding product component when a consumption amount of the one or more materials in the first group is a maximum consumption amount.

In an exemplary implementation mode, act 117 may include calculating a maximum consumption amount of one or more materials in the first group with respect to one or more product components in the first group and a satisfiable amount of the one or more materials in the first group with respect to the corresponding product component using a first linear programming model, according to the data of one or more materials in the first group, and calculating a satisfiable amount of one or more substitutable material groups in the first group with respect to the corresponding product component according to the satisfiable amount of the one or more materials in the first group with respect to the corresponding product component.

In an exemplary implementation mode, a first objective function of the first linear programming model is expressed as follows.

$$obj 1 = max {\sum }_{i = 1}^{N} {d}_{i} * {y}_{i} .$$

Herein, yᵢ represents an amount of a corresponding product component that can be produced using a corresponding material in the first group (i.e., a satisfiable amount of one or more materials in the first group for preparation of the corresponding product component); dᵢ represents a value of unit consumption of a corresponding material in the first group with respect to the corresponding product component; N is a positive integer representing a total number of corresponding materials in the first group, N≥1.

In an exemplary implementation mode, the first objective function is used to calculate a sum of maximum consumption amounts of one or more materials in the first group, and as shown in Table 4, satisfiable amounts of the one or more materials in the first group for preparation of a corresponding material with shortage in the second group are respectively set as follows: a satisfiable amount of a material A for preparation of a product component PRO-1 is set to y1, a satisfiable amount of a material B for the preparation of the product component PRO-1 is set to y2, a satisfiable amount of a material C for the preparation of the product component PRO-1 is set to y3, a satisfiable amount of a material D for the preparation of the product component PRO-1 is set to y4, a satisfiable amount of the material C for preparation of a product component PRO-4 is set to y5, and a satisfiable amount of a material H for preparation of the product component PRO-4 is set to y6; a value of unit consumption of the material A with respect to the product component PRO-1 is 1, a value of unit consumption of the material B with respect to the product component PRO-1 is 1, a value of unit consumption of the material C with respect to the product component PRO-1 is 2, a value of unit consumption of the material D with respect to the product component PRO-1 is 2, a value of unit consumption of the material C with respect to the product component PRO-4 is 2, and a value of unit consumption of the material H with respect to the product component PRO-4 is 2; maximum consumption amounts of one or more materials in the first group calculated using the linear programming model are as follows respectively: a maximum consumption amount of the material A with respect to the product component PRO-1 is y1, a maximum consumption amount of the material B with respect to the product component PRO-1 is y2, a maximum consumption amount of the material C with respect to the product component PRO-1 is 2*y3, a maximum consumption amount of the material D with respect to the product component PRO-1 is 2*y4, a maximum consumption amount of the material C with respect to the product component PRO-4 is 2*y5, and a maximum consumption amount of the material H with respect to the product component PRO-4 is 2*y6; a sum of maximum consumption amounts of one or more semi-finished components in the first group is: Max1=y1+y2+2y3+2y4+2y5+2y6.

In an exemplary implementation mode, the first objective function is constrained by a first constraint function, and the first constraint function of the first objective function is expressed as follows.

$${\sum }_{{x}_{i} ∈ ( {Q}_{l} , {G}_{j} )} {y}_{i} \leq {Q}_{l} .$$

Herein, Qₗ represents a demanded amount of an l-th product component in the first group, (Qₗ, Gⱼ) represents a set of variables (which may be a collection of variables) of a j-th group of materials with respect to the l-th product component, a plurality of materials in the j-th group may be substituted with each other in production of the l-th product component; 0≤yᵢ≤Qₗ; 1≤j≤J, wherein J represents a total number of groups of materials that may be substituted for each other in the production of the l-th product component.

In an exemplary implementation mode, the first constraint function of the first objective function may be understood as a constraint on a demanded amount of a corresponding product component, according to Table 4, product components to be prepared include the product component PRO-1 and the product component PRO-4 (i.e., a value of l is 2), a demanded amount Q₁ of the product component PRO-1 is 20,000, a demanded amount Q₂ of the product component PRO-4 is 1,300, a total number J of groups of materials that may be substituted for each other in preparation of the product component PRO-1 is 2 (a set of material groups include the material A and the material B, and the other set of material groups include the material C and the material D), and a total number J of groups of materials that may be substituted for each other in preparation of the product component PRO-4 is 1 (this group of materials include the material C and the material H), and a constraint on a demanded amount of a corresponding material in the first group is as follows.

A constraint on a demanded amount of the product component PRO-1 is: y1+y2≤20000; y3+y4≤20000.

A constraint on the product component PRO-4 is: y5+y6≤1300.

In an exemplary implementation mode, the first objective function may also be constrained by a second constraint function, and the second constraint function is expressed as follows.

$${\sum }_{{x}_{i} ∈ {X}_{m}} {d}_{i} * {y}_{i} \leq {C}_{m} .$$

Herein, Cₘ represents an available inventory amount of an m-th type of product component in the first group; Xₘ represents a set of variables (which may be a collection of variables) of the m-th product component; 1≤m≤M, wherein M represents a total number of types of product components in the first group.

In an exemplary implementation mode, the second constraint function of the first objective function may be understood as a constraint on an inventory amount of a corresponding material in the first group. As shown in Table 4, a total number M of types of materials in the first group is 5 (including: materials A, B, C, D, and H), an available inventory amount of the material A is 5,000, an available inventory amount of the material B is 2,000, an available inventory amount of the material C is 3,000, an available inventory amount of the material D is 1,000, an available inventory amount of the material H is 1,000, and a constraint on an inventory amount of a corresponding material in the first group is as follows.

A constraint on the inventory amount of the material A is: 0≤y1≤5000.

A constraint on the inventory amount of the material B is: 0≤y2≤2000.

A constraint on the inventory amount of the material C is: 0≤2y3+2y5≤1300.

A constraint on the inventory amount of the material D is: 0≤2y4≤1000.

A constraint on the inventory amount of the material H is: 0≤2y6≤1000.

In an exemplary implementation mode, the linear programming model is used above to calculate a maximum consumption amount of one or more materials in the first group with respect to one or more product components, and on a premise that the first constraint function and the second constraint function of the first objective function are satisfied, values of y1, y2, y3, y4, y5, and y6 that enables a sum (Max1) of maximum consumption amounts of the one or more materials in the first group to be maximized can be acquired, so as to reduce an inventory amount of a material as much as possible and a demanded amount of a product component as much as possible, thereby reducing overstock of materials and shortage of product components.

In an exemplary implementation mode, a linear programming model may be used to calculate a maximum consumption amount of each material in the first group with respect to at least one product of the one or more products. In some embodiments, the linear programming model is an integer linear programming model. In one example, the linear programming model is a pure integer linear programming model in which all variables are integers. In another example, the linear programming model is a mixed integer linear programming model in which some variables are integers and some are non-integers.

Various suitable approaches may be implemented in linear programming models. In one example, a branch-and-bound method may be used, which is based on a principle that a total set of feasible solutions may be divided into smaller subsets of solutions. Then, the smaller subsets may be systematically evaluated until an optimal solution is found. The branch-and-bound method may be implemented in a pure integer linear programming model, or it may be implemented in a mixed integer linear programming model. In another example, a cutting plane method may be used, which iteratively points to a feasible set or objective function by means of a linear inequality, referred to as cutting. The cutting plane method may be implemented in a pure integer linear programming model or a mixed integer linear programming model.

In an exemplary implementation mode, the satisfiable amount of one or more materials in the first group with respect to the corresponding product component calculated through the linear programming model in act 117 is a satisfiable amount of one or more materials in the first group for preparation of the corresponding product component when the one or more materials in the first group meet a maximum consumption amount with respect to one or more product components. In an exemplary implementation mode, the calculating the satisfiable amount of one or more substitutable material groups in the first group with respect to the corresponding product component according to the satisfiable amount of the one or more materials in the first group with respect to the corresponding product component may include: summing the satisfiable amounts of a plurality of materials located in a same substitution group in the first group for preparation of the corresponding product component to obtain a satisfiable amount of one or more substitutable material groups in the first group with respect to the corresponding product component.

As shown in Table 4, in a process of preparing the product component PRO-1, the material A and the material B are in a same substitution group, and a satisfiable amount y1 of the material A with respect to the product component PRO-1 is added with a satisfiable amount y2 of the material B with respect to the product component PRO-1 to obtain a satisfiable amount y1+y2 of the material A and the material B located in the same substitution group with respect to the product component PRO-1. In a same way, it may be obtained that a sum of satisfiable amounts of the material C and the material D in a same substitution group with respect to the product component PRO-1 is y3+y4, and a sum of satisfiable amounts of the material C and the material H in a same substitution group with respect to the product component PRO-4 is y5+y6.

Act 118: determining whether there is shortage in the one or more substitutable material groups in the first group with respect to a corresponding product component according to a satisfiable amount of one or more substitutable material groups in the first group with respect to the corresponding product component and a demanded amount for the one or more product components in the first group, if so, executing act 119; otherwise, calculating a remaining amount of one or more materials in the first group according to an inventory amount of the one or more materials in the first group and a maximum consumption amount of the one or more materials in the first group with respect to the one or more product components, and updating the inventory amount of the one or more materials in the first group using the remaining amount of the one or more materials in the first group.

In an exemplary implementation mode, in act 118, the determining whether there is shortage in the one or more substitutable material groups in the first group with respect to the corresponding product component according to the satisfiable amount of the one or more substitutable material groups in the first group with respect to the corresponding product component and the demanded amount for the one or more product components in the first group may include: when the satisfiable amount of one or more substitutable material groups in the first group with respect to a corresponding product component is greater than the demanded amount of the one or more product components in the first group, determining that there is no shortage in the one or more substitutable material groups in the first group with respect to the corresponding product component, and there is surplus in materials in the first group; when the satisfiable amount of one or more substitutable material groups in the first group with respect to the corresponding product component is equal to the demanded amount of the one or more product components in the first group, determining that there is no shortage in the one or more substitutable material groups in the first group with respect to the corresponding product component, and the materials in the first group are just enough to satisfy the demanded amount of the corresponding product component; when the satisfiable amount of one or more substitutable material groups in the first group with respect to the corresponding product component is less than the demanded amount of the one or more product components in the first group, determining that there is shortage in the one or more substitutable material groups in the first group with respect to the corresponding product component.

In an exemplary implementation mode, in act 118, the calculating the remaining amount of one or more materials in the first group according to the inventory amounts of the one or more materials in the first group and the maximum consumption amount of the one or more materials in the first group with respect to the one or more product components may include: using the inventory amount of the one or more materials in the first group to subtract the maximum consumption amount of the one or more materials in the first group with respect to one or more product components in the second group to obtain the remaining amount of the one or more materials in the first group.

Description is given by taking consumption of the material C and the material H for preparing the product component PRO-4 in Table 4 as an example: a priority of the material H is 1 and a priority of the material C is 2, then material H is preferentially used to prepare the product component PRO-4, and an inventory amount 1,000 of the material H is used to subtract a maximum consumption amount 2y6 of the material H with respect to the product component PRO-4 to obtain a remaining amount of the material H, which is 1000−2y6. When 1000−2y6 is greater than or equal to 0, it indicates that material H may meet a demanded amount of the product component PRO-4, and at this time, a demand of the product component PRO-4 may be met without consuming the material C. When 1000−2y6 is less than 0, it indicates that the material H cannot meet the demanded amount of the product component PRO-4, and the material C is used to supplement the demanded amount of the product component PRO-4. A satisfiable amount (y5) of the material C for preparation of the product component PRO-4 is equal to the demanded amount (1,300) of the product component PRO-4 minus a satisfiable amount (y6) of the material H for the preparation of the product component PRO-4, and an inventory amount 3,000 of the material C is used to subtract a maximum consumption amount 2y5 of the material C with respect to the product component PRO-4 to obtain a remaining amount of the material C, which is 3000−2y5=3000−2 (1300−y6). If a remaining amount 3000−2y5 of the material H is greater than or equal to 0, it indicates that the material C and the material H may meet the demanded amount of the product component PRO-4, there is no shortage in a material in the first group for the preparation of the product component PRO-4. If the remaining amount 3000−2y5 of the material C is less than 0, it indicates that the material H and the material C cannot meet the demanded amount of the product component PRO-4, and there is shortage in materials in the first group for the preparation of the product component PRO-4.

In an exemplary implementation mode, the inventory amount of the one or more materials in the first group is updated by using the remaining amount of the one or more materials in the first group, and the updated inventory amount may be used to determine whether there is shortage in a corresponding material in the first group in preparation of a corresponding product component, if the updated inventory amount is greater than or equal to 0, it indicates that there is no shortage in a corresponding material in the first group, and if the updated inventory amount is less than 0, it indicates that there is shortage in the corresponding material in the first group, an inventory amount is negative when there is shortage, and an absolute value of the inventory amount is a shortage amount.

In an exemplary implementation mode, description is given by taking a case in which the material H is consumed in preparation of the product component PRO-4 as an example, after preparing the product component PRO-4 using the material H, a remaining amount of the material H is 1000−2y6, and an inventory amount of the material H may be updated from 1,000 to 1000−2y6, so as to avoid the inventory amount of the material (H) being higher than an actual inventory amount, and thus materials may be effectively managed.

Act 119: determining whether there is a semi-finished component in a material group with shortage in the first group; if so, executing act 120; otherwise, updating an inventory amount of a corresponding material by using a remaining amount of the material with shortage in the first group, and calculating a shortage amounts of one or more substitutable material groups with respect to a product component according to a satisfiable amount of one or more substitutable material groups in the first group with respect to the corresponding product component and a demanded amount of the one or more product components in the first group.

In an exemplary implementation mode, restricted by the second constraint function of the first objective function, a remaining amount of a material with shortage in the first group is a number greater than or equal to 0.

In an exemplary implementation mode, the calculating the shortage amount of the one or more substitutable material groups with respect to the product component according to the satisfiable amount of one or more substitutable material groups in the first group with respect to the corresponding product component and the demanded amount of the one or more product components in the first group may include: using the demanded amount of the one or more product components in the first group to subtract the satisfiable amount of one or more substitutable material groups in the first group with respect to the corresponding product component to obtain the shortage amount of the one or more substitutable material groups with respect to the product component.

Act 120: acquiring material data of one or more semi-finished components of one or more material groups with shortage in the first group, and taking the one or more semi-finished components of the one or more material groups with shortage in the first group as a fifth group of semi-finished components.

In an exemplary implementation mode, material data of a plurality of semi-finished components of a material group with shortage in the first group (i.e., material data of the fifth group of semi-finished components) may include: a product number of a product component, a material number of a material with shortage, a material number of a semi-finished component, unit consumption of a semi-finished component by a product component (i.e., unit consumption of the semi-finished component with respect to a substitutable material), an inventory amount of the semi-finished component, a substitution group of the semi-finished component, and a shortage amount of the product component (which may be understood as a demanded amount of the product component that the semi-finished component needs to meet). The material data of the semi-finished components of the material groups with shortage in the first group may be shown in Table 6.

TABLE 6

| | | | Unit | | | | | | |
|---|---|---|---|---|---|---|---|---|---|
| | | | consumption | Unit | | | | | |
| | | | of a | consumption | | | | | Material |
| | | Material | semi- | of a | | Substitution | | | consumption |
| | | number | finished | semi- | Inventory | group | Shortage | | amount |
| | | of a | component | finished | amount of | of a | amount | | of a |
| | | semi- | by a | component | a semi- | semi- | of a | | semi- |
| Product | Material | finished | product | by a | finished | finished | product | Satisfiable | finished |
| Number | number | component | component | material | component | component | component | amount | component |
| PRO-1 | C | PCB-3 | 2 × 2 = 4 | 2 | 2000 | D6 | 20000-y3-y4 | p1 | 4p1 |
| PRO-1 | C | PCB-4 | 2 × 2 = 4 | 2 | 1500 | D6 | 20000-y3-y4 | p2 | 4p2 |
| PRO-1 | D | PCB-6 | 2 × 2 = 4 | 2 | 400 | D7 | 20000-y3-y4 | p3 | 4p3 |
| PRO-1 | D | PCB-7 | 2 × 2 = 4 | 2 | 2000 | D7 | 20000-y3-y4 | p4 | 4p4 |
| PRO-4 | C | PCB-3 | 2 × 2 = 4 | 2 | 2000 | D6 | 1300-x5-x6 | p5 | 4p5 |
| PRO-4 | C | PCB-4 | 2 × 2 = 4 | 2 | 1500 | D6 | 1300-x5-x6 | p6 | 4p6 |

As shown in Table 6, a semi-finished component PCB-3 and a semi-finished component PCB-4 are located in a same substitution group D6, and the semi-finished component PCB-1 and the semi-finished component PCB-2 may be substituted for each other in preparation of the material C; a semi-finished component PCB-6 and a semi-finished component PCB-7 are located in a same substitution group D7, and the semi-finished component PCB-6 and the semi-finished component PCB-7 may be substituted for each other in preparation of the material D; the material C may be used to prepare the product component PRO-1 and the product component PRO-4, therefore, the material C belongs to a common material for preparing the product component PRO-1 and the product component PRO-4.

Act 121: calculating a maximum consumption amount of one or more semi-finished components in the fifth group with respect to product components corresponding to one or more material groups with shortage in the first group according to material data of the one or more semi-finished components in the fifth group.

In an exemplary implementation mode, the calculating the maximum consumption amount of one or more semi-finished components in the fifth group with respect to product components corresponding to one or more material groups with shortage in the first group according to the material data of the one or more semi-finished components in the fifth group may include: calculating the maximum consumption amount of one or more semi-finished components in the fifth group with respect to product components corresponding to one or more material groups with shortage in the first group using a fifth linear programming model.

In an exemplary implementation mode, a fifth objective function of the fifth linear programming model is expressed as follows.

$$obj 5 = max {\sum }_{i = 1}^{N} {d}_{i} * {p}_{i} .$$

Herein, pᵢ represents an amount of product components corresponding to a corresponding material with shortage in the first group that can be produced using a corresponding semi-finished component in the fifth group (i.e., a satisfiable amount of one or more semi-finished components in the fifth group for preparation of product components corresponding to a corresponding material with shortage in the first group); dᵢ representing a value of unit consumption of a corresponding semi-finished component in the fifth group with respect to a product component corresponding to one or more corresponding materials with shortage in the first group; N is a positive integer representing a total number of corresponding semi-finished components in the fifth group, N≥1.

In an exemplary implementation mode, the fifth objective function is used to calculate a sum of maximum consumption amounts of one or more semi-finished components in the fifth group, and as shown in Table 6, satisfiable amounts of one or more semi-finished components in the fifth group for preparation of product components corresponding to a corresponding material with shortage in the first group are respectively set as follows: a satisfiable amount of a semi-finished component PCB-3 for preparation of the product component PRO-1 corresponding to the material C with shortage is set to p1, a satisfiable amount of a semi-finished component PCB-4 for preparation of the product component PRO-1 corresponding to the material C with shortage is set to p2, a satisfiable amount of a semi-finished component PCB-6 for preparation of the product component PRO-1 corresponding to the material D with shortage is set to p3, a satisfiable amount of a semi-finished component PCB-7 for preparation of the product component PRO-1 corresponding to the material D with shortage is set to p4, a satisfiable amount of the semi-finished component PCB-3 for preparation of the product component PRO-4 corresponding to the material C with shortage is set to p5, and a satisfiable amount of the semi-finished component PCB-4 for preparation of the product component PRO-4 corresponding to the material C with shortage is set to p6; a value of unit consumption of the semi-finished component PCB-3 with respect to the product component PRO-1 corresponding to the material C with shortage is 4, a value of unit consumption of the semi-finished component PCB-4 with respect to the product component PRO-1 corresponding to the material C with shortage is 4, a value of unit consumption of the semi-finished component PCB-6 with respect to the product component PRO-1 corresponding to the material D with shortage is 4, a value of unit consumption of the semi-finished component PCB-7 with respect to the product component PRO-1 corresponding to the material D with shortage is 4, a value of unit consumption of the semi-finished component PCB-3 with respect to the product component PRO-4 corresponding to the material C with shortage is 4, and a value of unit consumption of the semi-finished component PCB-4 with respect to the product component PRO-4 corresponding to the material C with shortage is 4. Maximum consumption amounts of one or more semi-finished components in the fifth group calculated using a linear programming model, are respectively as follows: a maximum consumption amount of the semi-finished component PCB-3 with respect to the product component PRO-1 corresponding to the material C with shortage is 4*p1, a maximum consumption amount of the semi-finished component PCB-4 with respect to the product component PRO-1 corresponding to the material C with shortage is 4*p2, a maximum consumption amount of the semi-finished component PCB-6 with respect to the product component PRO-1 corresponding to the material D with shortage is 4*p3, a maximum consumption amount of the semi-finished component PCB-7 with respect to the product component PRO-1 corresponding to the material D with shortage is 4*p4, a maximum consumption amount of the semi-finished component PCB-3 with respect to the product component PRO-4 corresponding to the material C with shortage is 4*p5, and a maximum consumption amount of the semi-finished component PCB-4 with respect to the product component PRO-4 corresponding to the material C with shortage is 4*p6; a sum of maximum consumption amounts of one or more semi-finished components in the fifth group is:

$$Max 5 = 4 p 1 + 4 p 2 + 4 p 3 + 4 p 4 + 4 p 5 + 4 p 6.$$

In an exemplary implementation mode, the fifth objective function is constrained by a first constraint function, and the first constraint function is expressed as follows.

$${\sum }_{{x}_{i} ∈ ( {Q}_{l} , {G}_{j} )} {p}_{i} \leq {Q}_{l} .$$

Herein, Qₗ represents a shortage amount (i.e., a demanded amount) of a product component corresponding to an l-th material with shortage in the first group; (Qₗ, Gⱼ) represents a set of variables (which may be a collection of variables) of a j-th group of semi-finished components with respect to the l-th material with shortage, and a plurality of semi-finished components in the j-th group may be substituted for each other in production of the l-th material with shortage; 0=pᵢ≤Qₗ; 1≤j≤J, wherein J represents a total number of groups of semi-finished components that may be substituted for each other in production of the l-th material with shortage.

In an exemplary implementation mode, the first constraint function of the fifth objective function may be understood as a constraint on a shortage amount of a product component corresponding to a corresponding material with shortage in the first group (i.e., a demanded amount of the product component corresponding to the corresponding material with shortage in the first group). According to Table 6, there is shortage in the product component PRO-1 corresponding to the material C and the material D, and there is shortage in the product component PRO-4 corresponding to the material C (i.e., a value of l is 3), a shortage amount Q₁ of the product component PRO-1 corresponding to the material C is 20000−y1−y2, a shortage amount Q₂ of the product component PRO-1 corresponding to the material D is 20000−y1−y2, a shortage amount Q₃ of the product component PRO-4 corresponding to the material C is 1300−y5−y6, a total number J of groups of semi-finished components that may be substituted with each other in preparation of the product component PRO-1 corresponding to the material C is 1 (the group of semi-finished components includes the semi-finished component PCB-3 and the semi-finished component PCB-4), a total number J of groups of semi-finished components that may be substituted with each other in the preparation of the product component PRO-1 corresponding to the material D is 1 (the group of semi-finished components includes the semi-finished component PCB-6 and the semi-finished component PCB-7), and a total number J of groups of semi-finished components that may be substituted with each other in preparation of the product component PRO-4 corresponding to the material C is 1 (the group of semi-finished components includes the semi-finished component PCB-3 and the semi-finished component PCB-4), a constraint on a shortage amount of a product component corresponding to a corresponding material with shortage in the second group is as follows.

A constraint on a shortage amount of the product component PCB-1 corresponding to the material C and the material D with shortage in the first group is as follows: p1+p2+p3+p4≤20000−y3−y4.

A constraint on a shortage amount of the product component PCB-4 corresponding to the material C with shortage in the first group is: p5+p6≤1300−y5−y6.

In an exemplary implementation mode, the fifth objective function may also be constrained by a second constraint function, and the second constraint function is expressed as follows.

$${\sum }_{{x}_{i} ∈ {X}_{m}} {d}_{i} * {p}_{i} \leq {C}_{m} .$$

Herein, Cₘ represents an available inventory amount of an m-th type of semi-finished component in the fifth group; Xₘ represents a set of variables (which may be a collection of variables) representing the m-th semi-finished component; 1≤m≤M, wherein M represents a total number of types of semi-finished components in the fifth group.

In an exemplary implementation mode, the second constraint function of the fifth objective function may be understood as a constraint on an inventory amount of a corresponding semi-finished component in the fifth group, as shown in Table 6, a total number M of types of semi-finished components in the fifth group is 4 (including: a semi-finished component PCB-13, the semi-finished component PCB-4, the semi-finished component PCB-6, and the semi-finished component PCB-7), an available inventory amount of the semi-finished component PCB-3 is 2,000, an available inventory amount of the semi-finished component PCB-4 is 1,500, an available inventory amount of the semi-finished component PCB-6 is 400, and an available inventory amount of the semi-finished component PCB-7 is 2,000, and a constraint on an inventory amount of a corresponding semi-finished component in the fifth group is as follows.

A constraint on the inventory amount of the semi-finished component PCB-3 is: 4p1+4p5≤1000.

A constraint on the inventory amount of the semi-finished component PCB-4 is: 4p2+4p6≤1500.

A constraint on the inventory amount of the semi-finished component PCB-6 is: 4p3≤400.

A constraint on the inventory amount of the semi-finished component PCB-7 is: 4p4≤2000.

In an exemplary implementation mode, the fifth linear programming model is used above to calculate the maximum consumption amount of the one or more semi-finished components in the fifth group with respect to product components corresponding to one or more materials with shortage in the first group, and on a premise that the first constraint function and the second constraint function of the fifth objective function are satisfied, values of p1, p2, p3, and p4 that enables a sum (Max5) of maximum consumption amounts of the one or more semi-finished components in the fifth group to be maximized are acquired, so as to reduce an inventory amount of a semi-finished component as much as possible and replenish a shortage amount of a material with shortage in the first group as much as possible, thereby reducing overstock of the semi-finished component and reduce shortage of the material in the first group.

Act 122: calculating a remaining amount of one or more semi-finished components in the fifth group according to an inventory amount of the one or more semi-finished components in the fifth group and a maximum consumption amount of the one or more semi-finished components in the fifth group with respect to a product component corresponding to one or more corresponding materials with shortage in the first group, and updating the inventory amount of the one or more semi-finished components in the fifth group using the remaining amount of the one or more semi-finished components in the fifth group.

In an exemplary implementation mode, in act 125, the calculating a remaining amount of one or more semi-finished components in the third group according to the inventory amount of the one or more semi-finished components in the fifth group and the maximum consumption amount of the one or more semi-finished components in the fifth group with respect to the product component corresponding to one or more corresponding materials with shortage in the first group may include: using the inventory amount of the one or more semi-finished components in the fifth group to subtract the maximum consumption amount of the one or more semi-finished components in the fifth group with respect to the product component corresponding to one or more corresponding materials with shortage in the first group to obtain the remaining amount of the one or more semi-finished components in the fifth group.

In an exemplary implementation mode, restricted by the second constraint function of the fifth objective function, a remaining amount of a material of the one or more semi-finished components in the fifth group is a number greater than or equal to 0.

In an exemplary implementation mode, description is given by taking a case in which the semi-finished component PCB-6 is consumed in preparation of the product component PRO-1 corresponding to the material D as an example, a remaining amount of the semi-finished component PCB-6 is 400-4p3 after a shortage amount of the product component PRO-1 corresponding to the material D is supplemented by using the semi-finished component PCB-6, and an inventory amount of the semi-finished component PCB-6 may be updated from 400 to 400−4p3, so as to avoid the inventory amount of the semi-finished component (PCB-6) being higher than an actual inventory amount, and materials of semi-finished components may be effectively managed.

Act 123: calculating a fifth shortage value according to a satisfiable amount of the one or more semi-finished components in the fifth group for preparation of a product component corresponding to a corresponding material group with shortage in the first group and a shortage amount of the product component corresponding to the corresponding material group with shortage in the first group, and updating a shortage amount of a product component corresponding to a corresponding material with shortage in the first group using the fifth shortage value.

In an exemplary implementation mode, the calculating the fifth shortage value according to the satisfiable amount of the one or more semi-finished components in the fifth group for the preparation of the product component corresponding to the corresponding material group with shortage in the first group and the shortage amount of the product component corresponding to the corresponding material group with shortage in the first group may include: using the shortage amount of the product component corresponding to the corresponding material group with shortage in the first group to subtract the satisfiable amount of the one or more semi-finished components in the fifth group for preparation of the product component corresponding to the corresponding material group with shortage in the first group to obtain the fifth shortage value of the product component corresponding to the corresponding material group in the first group.

Herein, the satisfiable amount of the one or more semi-finished components in the fifth group for the preparation of the product component corresponding to the corresponding material group with shortage in the first group is equal to a sum of integer data after rounded down from a ratio between an inventory amount amount of the one or more semi-finished components in the fifth group and a value of unit consumption of the one or more semi-finished components in the fifth group with respect to the product component corresponding to the corresponding material with shortage in the first group. In an exemplary implementation mode, the satisfiable amount of the one or more semi-finished components in the fifth group for preparation of the product component corresponding to the corresponding material group with shortage in the first group is obtained when calculating the maximum consumption amount of one or more semi-finished components in the fifth group with respect to the product component corresponding to one or more material groups with shortage in the first group using a fifth linear programming model. As shown in Table 6, a satisfiable amount of the semi-finished component PCB-3, the semi-finished component PCB-4, the semi-finished component PCB-6, and the semi-finished component PCB-7 for preparation of the product component PRO-1 corresponding to substitutable material groups C and Dis p1+p2+p3+p4.

In an exemplary implementation mode, a shortage amount of a product component corresponding to a corresponding material group with shortage in the first group=a demanded amount of the corresponding product component−a satisfiable amount of a substitution group with respect to the corresponding product component.

The satisfiable amount of the substitution group with respect to the corresponding product component=a satisfiable amount of a first group of materials with respect to the corresponding product component+a satisfiable amount of the fifth group of semi-finished components with respect to the corresponding product component.

As shown in Table 4 and Table 6, description is given by taking substitutable group materials C and D for preparation of the product component PRO-1 as an example: a satisfiable amount of substitutable group materials C and D with respect to the corresponding product component PRO-1 is y3+y4, a satisfiable amount of the semi-finished component PCB-3, the semi-finished component PCB-4, the semi-finished component PCB-6, and the semi-finished component PCB-7 in the fifth group with respect to the corresponding product component PRO-1 is p1+p2+p3+p4, a demanded amount of the product component PRO-1 is 20,000, and a shortage amount of the product component PRO-1=20000−y3−y4; a final shortage amount of the product component PRO-1=20000−y3−y4−(p1+p2+p3+p4). The fifth shortage value may be p1+p2+p3+p4−(20000−y3−y4).

Act 124: calculating a sixth shortage value according to the satisfiable amount of the one or more semi-finished components in the fifth group for preparation of the corresponding material with shortage in the first group and the shortage amount of the corresponding material group with shortage in the first group, and updating the shortage amount of the corresponding material group with shortage in the first group using the sixth shortage value.

In an exemplary implementation mode, the calculating the sixth shortage value according to the satisfiable amount of the one or more semi-finished components in the fifth group for the preparation of the corresponding material with shortage in the first group and the shortage amount of the corresponding material with shortage in the first group may include: using the shortage amount of the corresponding material with shortage in the first group to subtract the satisfiable amount of the one or more semi-finished components in the fifth group for the preparation of the corresponding material with shortage in the first group to obtain a sixth shortage value of the corresponding material in the first group.

Herein, the satisfiable amount of the one or more semi-finished components in the fifth group for the preparation of the corresponding material with shortage in the first group is equal to integer data rounded down from a ratio between an inventory amount of the one or more semi-finished components in the fifth group and a value of unit consumption of the one or more semi-finished components in the fifth group with respect to the corresponding material with shortage in the first group. In an exemplary implementation mode, the satisfiable amount corresponding to one or more semi-finished components in the fifth group for the preparation of the corresponding material with shortage in the first group may be obtained by a sum of products between a satisfiable amount of a product component corresponding to the corresponding material with shortage in the first group prepared by one or more semi-finished components in the fifth group and a value of unit consumption of the corresponding material with shortage in the first group with respect to the corresponding product component. As shown in Table 6, when semi-finished components PCB-3 and PCB-4 are used to prepare the product component PRO-4 corresponding to the material C, a satisfiable amount of semi-finished components PCB-3 and PCB-4 with respect to the material C is 2p5+2p6. A sixth shortage value of the material C may be obtained by using a shortage amount (1300−y5−y6)/2 of material groups C and H in preparation of the product component PRO-4 to subtract the satisfiable amount 2p5+2p6 of semi-finished components PCB-3 and PCB-4 with respect to the material C, that is, the sixth shortage value of the material C=(1300−y5−y6)/2−(2p5+2p6).

Act 125: acquiring a configuration parameter, allocating a shortage amount of a material with shortage in a corresponding material group with shortage in the first group according to the configuration parameter, updating a shortage amount of a corresponding material in the first group using an allocated shortage amount.

In an exemplary implementation mode, the configuration parameter may include a priority of a corresponding material with shortage in the first group. Act 125 may include: performing shortage amount allocation to the shortage amount of the corresponding material with shortage in the first group according to a priority number of the material. In an exemplary implementation mode, a material with a higher priority is preferentially assigned a shortage amount.

As shown in Table 7, an example of allocating a shortage amount to a material with shortage in the first group according to a material priority is shown.

TABLE 7

| | | Unit | | | | |
|---|---|---|---|---|---|---|
| | | consumption | | | | |
| | | of a | | | | |
| | | substitution | | Demanded | | |
| | | material | | amount of | | Allocated |
| | | with respect | Substitution | shortage | | material |
| Product | Substitution | to a product | material | of product | Substitution | shortage |
| component | material | component | priority | component | group | amount |
| PRO-1 | C | 2 | 1 | 1000 | D2 | 2 × 1000 = 200 |
| | | | | | | 0 |
| PRO-1 | D | 2 | 2 | 1000 | D2 | 0 |
| PRO-4 | C | 2 | 2 | 200 | D3 | 0 |
| PRO-4 | H | 2 | 1 | 200 | D3 | 2 × 200 = 400 |

In an exemplary implementation mode, the configuration parameter is not limited to a priority of a substitution material, and may be set according to actual business requirements, for example, a shortage amount may be allocated according to a size of a shared quantity of substitution materials and a size of possibility of use of a substitution material.

In an exemplary implementation mode, in a process of preparing one or more product components, a consumption amount of a material (necessary material or non-substitutable material) in the first group is calculated firstly, when there is shortage in the material in the first group, a semi-finished component of a corresponding material is acquired, the semi-finished component is converted into the corresponding material in the first group, a shortage or overstock state of the material in the first group is acquired, and based on completion of calculation of material consumption of the first group and a corresponding semi-finished component, a consumption amount of a material in the second group (substitutable material) is calculated, when there is shortage in a material in the second group and there is a semi-finished component, a material of the semi-finished component is converted into a corresponding material in the second group, and an overstock quantity or shortage quantity of the first group, the second group, and a corresponding semi-finished component are finally obtained, when a remaining amount of a material is greater than 0, it is called an overstock quantity, and when the remaining quantity of the material is less than 0, it is called a shortage quantity (or the shortage quantity is calculated based on the remaining quantity).

In an exemplary implementation mode, act 122 may be followed by act M0: when it is determined that there is shortage in one or more next-level materials in the fifth group according to a remaining amount of the one or more next-level materials in the fifth group, acquiring a configuration parameter of a next-level material, reallocating a shortage amount of a material with shortage in a corresponding next-level material group with shortage in the fifth group according to the configuration parameter of the next-level material, updating a shortage amount of a corresponding next-level material in the fifth group using a reallocated shortage amount, and displaying an updated shortage amount and shortage state of the corresponding next-level material in the fifth group through the first output interface; when it is determined that there is no shortage in the one or more next-level materials in the fifth group according to the remaining amount of the one or more next-level materials in the fifth group and the remaining amount is greater than 0, outputting the remaining amount and an overstock state of the one or more next-level materials in the fifth group through a first display interface; when it is determined that there is no shortage in the one or more next-level materials in the fifth group and the remaining amount is equal to 0, outputting the remaining amount and a material state of the one or more next-level materials in the fifth group through the first display interface.

In an exemplary implementation mode, acts 123 to 125 may be substituted with act M0, or both act M0 and acts 123 to 125 are performed.

In an exemplary implementation mode, after act 123 and before act 124, the method may further include: outputting a shortage amount of a product component corresponding to a corresponding material with shortage in the first group through the first display interface.

In an exemplary implementation mode, after act 124 and before act 125, the method may further include outputting a shortage amount of a corresponding material with shortage in the first group through the first display interface.

In an exemplary implementation mode, after act 125, the method may further include: outputting a shortage amount of a corresponding material with shortage in an updated first group through the first display interface.

In an exemplary implementation mode, the shortage amount of the corresponding material in the first group obtained in act 125, the shortage amount of the product component corresponding to the material with shortage in the first group acquired in act 123, the inventory amount of the semi-finished component in the fifth group obtained in act 122, the shortage amount of the substitutable material group with respect to the product component obtained in act 119, the inventory amount (i.e., the remaining amount) of one or more materials in the first group in act 118, the inventory amount of the corresponding material with shortage in the second group in act 107, and the inventory amount of the corresponding material in the second group in act 106 may be used as reference data for the corresponding material to be overstocked or short.

In an exemplary implementation mode, the inventory amount of the semi-finished component in the third group obtained in act 113, the shortage amount of the corresponding material with shortage in the second group obtained in act 114, and the shortage amount of the semi-finished component in the third group and the shortage amount of the semi-finished component in the fourth group obtained in act 115 may be used as reference data for a material of a corresponding semi-finished component to be overstocked or short when subsequent calculation of a substitutable material consumed by the material in the second group does not involve materials of corresponding semi-finished components in the third and fourth groups. When the subsequent calculation of the substitutable material consumed by the material in the second group involves the materials of the corresponding semi-finished components in the third and fourth groups, the data of the semi-finished components involved is not final data, and final data obtained by calculating a consumption amount of the second group is used as reference data for a material to be overstocked or short.

In an exemplary implementation mode, after acquiring the remaining amounts of one or more semi-finished components in the fourth group in act 111, the method may further include: when the remaining amount of the one or more semi-finished components in the fourth group is greater than 0, determining whether the one or more materials in the fourth group are substitutable materials with respect to at least one of one or more materials with shortage in the first group and the third group according to the information on the substitution relationships among semi-finished components in the fourth group; when it is determined that one or more materials in the fourth group are not substitutable materials with respect to one or more materials with shortage in the first group and the third group, determining that there is overstock in one or more materials in the fourth group; when it is determined that one or more materials in the fourth group are substitutable materials with respect to the one or more materials with shortage in the first group and the third group, it is necessary to determine an overstock or shortage state of one or more materials in the fourth group according to a situation of consumption of the one or more materials in the fourth group by the first group and the third group.

In an exemplary implementation mode, the semi-finished component described above may be used as a next-level material of a material for preparing a product component.

In an exemplary implementation mode, the computer-implemented method described above may be performed by a processor executing executable instructions stored in a memory.

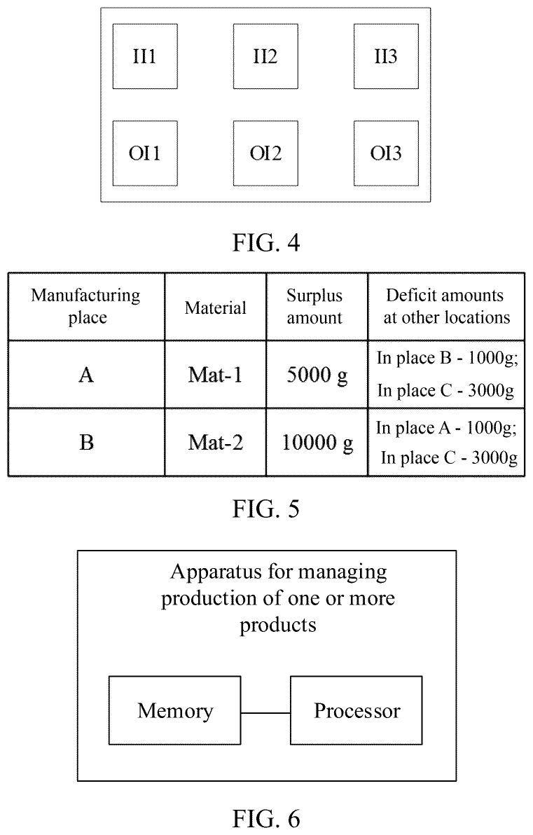

In an exemplary implementation mode, as shown in FIG. 4, the computer-implemented method may further include: generating one or more user interfaces.

Herein, the one or more user interfaces may include a first output interface OI1 configured to display a material state of a corresponding material in at least one of the first group to the fourth group.

In an exemplary implementation mode, the material state may include: material shortage, material overstock, and material just met.

In an exemplary implementation mode, as shown in FIG. 4, the one or more user interfaces may further include a first input interface II1 configured to receive one or more user inputs for querying a database; data of the plurality of materials is stored in the database.

Herein, the computer-implemented method may further include: receiving, from the first input interface II1, user selection of one or more conditions, wherein the user selection is for selecting a material state associated with the one or more conditions; and in response to the user selection, querying the database to determine one or more material states associated with the one or more conditions in the database; the one or more conditions may include at least one of an overstock state of an overstocked material and shortage state of a material with shortage; the one or more user interfaces may further include a second output interface OI2 configured to display one or more overstocked materials or materials with shortage as a result of querying the database. In an exemplary implementation mode, the one or more conditions further include at least one of an identification number of a manufacturing place, an identification number of a material, or a date range.

In an exemplary implementation mode, the second output interface OI2 may be further configured to display an identification number of one or more products produced from one or more overstocked materials. In an exemplary implementation mode, the second output interface OI2 may also be configured to display a demand for an overstocked material for manufacturing a corresponding product component. Users may analyze a relationship between a demand and an overstock state.

In an exemplary implementation mode, the one or more user interfaces may further include a second input interface II2 configured to receive one or more user inputs for adjusting a priority of a corresponding material in the first group.

Herein, the computer-implemented method may further include re-determining whether a corresponding material in the first group is overstocked or short based on an adjusted priority of the corresponding material in the first group.

In an exemplary implementation mode, the second input interface II2 may be further configured to receive one or more user inputs for adjusting a priority of a corresponding next-level material in the third group.

Herein, the computer-implemented method may further include re-determining whether a corresponding next-level material in the third group is overstocked or short based on an adjusted priority of the corresponding next-level material in the second group.

In an exemplary implementation mode, the one or more user interfaces may further include a third input interface II3 configured to receive one or more user inputs for adjusting a demand for one or more product components.

Herein, the computer-implemented method may further include: calculating an adjusted maximum consumption amount of a corresponding material in the first group based on an adjusted demand for the one or more product components; comparing the adjusted maximum consumption amount of the corresponding material in the first group with an available inventory amount of the corresponding material in the first group; re-determining whether there is overstock or shortage in the corresponding material in the first group. In an exemplary implementation mode, the one or more user interfaces may further include a third input interface II3 configured to receive one or more user inputs for adjusting a demand for one or more products. The memory further stores computer-executable instructions for controlling one or more processors to: calculate an adjusted maximum consumption amount of the corresponding material in the first group during a cycle based on an adjusted demand for one or more products; comparing the adjusted maximum consumption amount of the corresponding material in the first group with an available inventory amount of the corresponding material in the first group; re-determining whether the corresponding material in the first group is overstocked. By adjusting the demand for the one or more products, material overstock may be reduced, manufacturers may better cater to the market, and products may be supplied more quickly.

The one or more user interfaces may further include a third output interface OI3 configured to display an estimated surplus amount with respect to an overstocked material at a first manufacturing place and an estimated deficit amount with respect to the overstocked material at a second manufacturing place. Optionally, the third output interface OI3 is configured to display a table including an identification number of the overstocked material, an identification number of a manufacturing place, the estimated surplus amount, and the estimated deficit amount.

FIG. 5 illustrates a third output interface OI3 according to some embodiments of the present disclosure. Referring to FIG. 5, the third output interface OI3 is configured to display that a material Mat-1 has a surplus amount of 5,000 g that is overstocked at a manufacturing place A, a deficit amount of 1,000 g that is deficient at a manufacturing place B, and a deficit amount of 3000 g that is deficient at a manufacturing place C. In some embodiments, a user may allocate an overstocked material between manufacturing places based on several factors including shipping costs, urgency of needing the overstocked material at the second manufacturing place, and the like.

In some embodiments, the computer-implemented method may further include: when it is determined that there is overstock of a corresponding material in the first group, adjusting a demand for one or more product components to minimize material overstock; and producing the one or more product components based on the adjusted demand for the one or more products. By adjusting the demand for the one or more product components, material overstock may be reduced, manufacturers may better cater to the market, and products may be supplied more quickly.

In an exemplary implementation mode, a remaining amount of a material being greater than 0 indicates that there is overstock of the material, and an overstock amount may be updated by using the remaining amount, and the remaining amount being less than 0 indicates that there is shortage of the material, and a shortage amount may be updated by using the remaining amount. An available inventory amount and an inventory amount both represent a quantity of materials that may be used before preparing a corresponding product component or a semi-finished component of a product component. The remaining amount is usually obtained by subtracting a consumption amount from the inventory amount (or available inventory amount); after preparation of the corresponding product component, an inventory amount of a corresponding material may be updated by using the remaining amount of the corresponding material.

An embodiment of the present disclosure also provides an apparatus for managing production of one or more products, and in an exemplary implementation mode, as shown in FIG. 6, the apparatus for managing production of one or more products may include: a memory; one or more processors.

Herein, the memory and the one or more processors are connected with each other; the memory stores computer-executable instructions for controlling the one or more processors to perform following operations: acquiring data of a plurality of next-level materials of one or more materials with shortage for manufacturing one or more product components; wherein the data of the plurality of next-level materials of the one or more materials with shortage includes available inventory amounts of the plurality of next-level materials; calculating maximum consumption amounts of the plurality of next-level materials with respect to at least one of the one or more materials with shortage; and determining whether there is shortage in the one or more materials with shortage according to a maximum consumption amount and an available inventory amount of a corresponding material of the plurality of next-level materials.

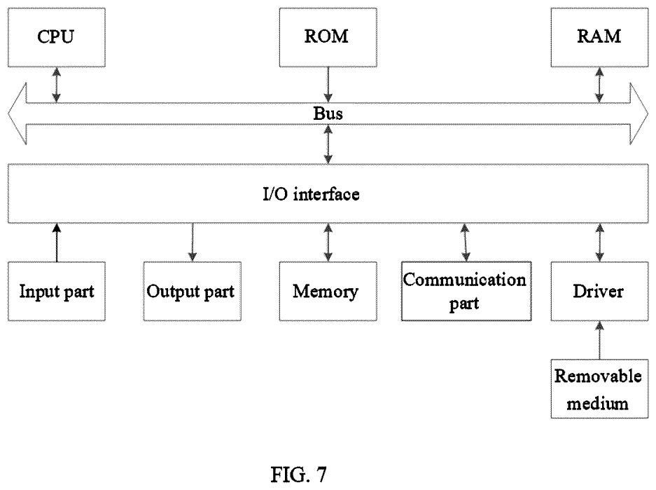

In an exemplary implementation mode, FIG. 7 is a schematic diagram of a structure of an apparatus according to some embodiments of the present disclosure. Referring to FIG. 7, in some embodiments, the apparatus includes a Central Processing Unit (CPU) configured to perform actions according to computer-executable instructions stored in a Read Only Memory (ROM) or Random Access Memory (RAM). In an exemplary implementation mode, data and programs required by a computer system are stored in the RAM. In an exemplary implementation mode, the CPU, the ROM, and the RAM are electrically connected with each other through a bus. In an exemplary implementation mode, an input/output interface is electrically connected to the bus.

In an exemplary implementation mode, the apparatus for managing production of one or more products may be configured to manage production of one or more final products, or to manage production of one or more semi-finished components. In an exemplary implementation mode, a product may be a final product or product component, or may be a semi-finished component, and the semi-finished component may be a next-level material of a material for preparing the product component.

An embodiment of the present disclosure also provides a computer program product including a non-transitory tangible computer-readable medium having computer-readable instructions thereon, and the computer-readable instructions can be executed by a processor to enable the processor to perform: acquiring data of a plurality of next-level materials of one or more materials with shortage for manufacturing one or more product components; wherein the data of the plurality of next-level materials of the one or more materials with shortage includes available inventory amounts of the plurality of next-level materials; calculating maximum consumption amounts of the plurality of next-level materials with respect to at least one of the one or more materials with shortage; and determining whether there is shortage in the one or more materials with shortage according to a maximum consumption amount and an available inventory amount of a corresponding material of the plurality of next-level materials.

An embodiment of the present disclosure also provides an apparatus for managing production of one or more products. Referring to FIG. 6, an apparatus for managing production of one or more products may include: a memory; and one or more processors.

Herein, the memory and the one or more processors are connected with each other; the memory stores computer-executable instructions for controlling the one or more processors to perform following operations: receiving a material query instruction input by a user through a first input interface; in response to the material query instruction, acquiring, from a data source, data of a plurality of materials for manufacturing one or more product components, wherein the data of the plurality of materials includes available inventory amounts of the plurality of materials; calculating maximum consumption amounts of the plurality of materials with respect to at least one of the one or more product components; and determining whether there is shortage in one or more materials for manufacturing the one or more product components according to a maximum consumption amount of a corresponding material of the plurality of materials and an available inventory amount of the corresponding material of the plurality of materials.

An embodiment of the present disclosure also provides a computer program product including a non-transitory tangible computer-readable medium having computer-readable instructions thereon, and the computer-readable instructions can be executed by a processor to enable the processor to perform: receiving a material query instruction input by a user through a first input interface; in response to the material query instruction, acquiring, from a data source, data of a plurality of materials for manufacturing one or more product components, wherein the data of the plurality of materials includes available inventory amounts of the plurality of materials; calculating maximum consumption amounts of the plurality of materials with respect to at least one of the one or more product components; and determining whether there is shortage in one or more materials for manufacturing the one or more product components according to a maximum consumption amount of a corresponding material of the plurality of materials and an available inventory amount of the corresponding material of the plurality of materials.

Embodiments of the present disclosure provide a computer-implemented method, an apparatus for managing production of one or more products, and a computer program product, wherein the computer-implemented method includes: receiving a material query instruction input by a user through a first input interface; in response to the material query instruction, acquiring, from a data source, data of a plurality of materials for manufacturing one or more product components, wherein the data of the plurality of materials includes available inventory amounts of the plurality of materials; calculating maximum consumption amounts of the plurality of materials with respect to at least one of the one or more product components; and determining whether there is shortage in one or more materials for manufacturing the one or more product components according to a maximum consumption amount of a corresponding material of the plurality of materials and an available inventory amount of the corresponding material of the plurality of materials; a technical solution according to an embodiment of the present disclosure may solve a problem of material overstock or shortage in a process of material management.

Those of ordinary skills in the art may understand that all or some of acts in the methods disclosed above, systems, functional modules or units in apparatuses may be implemented as software, firmware, hardware, and an appropriate combination thereof. In a hardware implementation mode, division of the function modules/units mentioned in the above description is not always corresponding to division of physical components. For example, a physical component may have multiple functions, or a function or an act may be executed by several physical components in cooperation. Some components or all components may be implemented as software executed by a processor such as a digital signal processor or a microprocessor, or implemented as hardware, or implemented as an integrated circuit such as an application specific integrated circuit. Such software may be distributed on a computer readable medium, and the computer readable medium may include a computer storage medium (or a non-transitory medium) and a communication medium (or a transitory medium). As known to those of ordinary skills in the art, a term computer storage medium includes volatile and nonvolatile, and removable and irremovable media implemented in any method or technology for storing information (for example, a computer readable instruction, a data structure, a program module, or other data). The computer storage medium includes, but is not limited to, a RAM, a ROM, an Electrically Erasable Programmable Read Only Memory (EEPROM), a flash memory or another memory technology, a Compact Disc Read Only Memory (CD-ROM), a Digital Versatile Disk (DVD) or another optical disk storage, a magnetic cartridge, a magnetic tape, magnetic disk storage or another magnetic storage apparatus, or any other medium that may be configured to store desired information and may be accessed by a computer. In addition, it is known to those of ordinary skill in the art that the communication medium usually includes a computer readable instruction, a data structure, a program module, or other data in a modulated data signal of, such as, a carrier wave or another transmission mechanism, and may include any information delivery medium.

The embodiments of the present invention, i.e., features in the embodiments, may be combined with each other to obtain new embodiments if there is no conflict.

Although the implementation modes disclosed in the present disclosure are as above, the described contents are only implementation modes used for convenience of understanding the present disclosure and are not intended to limit the present disclosure. Any of those skilled in the art of the present disclosure may make any modification and variation in form and details of implementation without departing from the spirit and scope of the present disclosure. However, the protection scope of the present disclosure should be subject to the scope defined in the appended claims.

1. A computer-implemented method, comprising:
receiving a material query instruction input by a user through a first input interface;
in response to the material query instruction, acquiring, from a data source, data of a plurality of materials for manufacturing one or more product components, wherein the data of the plurality of materials comprises available inventory amounts of the plurality of materials;
calculating maximum consumption amounts of the plurality of materials with respect to at least one of the one or more product components; and
determining whether there is shortage in one or more materials for manufacturing the one or more product components according to a maximum consumption amount of a corresponding material of the plurality of materials and an available inventory amount of the corresponding material of the plurality of materials.

2. The computer-implemented method according to claim 1, further comprising:
determining whether there is a next-level material for a material with shortage when it is determined that there is shortage in the plurality of materials for manufacturing the one or more product components;
acquiring data of a plurality of next-level materials of one or more materials with shortage for manufacturing the one or more product components when it is determined that there is the next-level material for the material with shortage, the data of the plurality of next-level materials of the one or more materials with shortage comprises available inventory amounts of the plurality of next-level materials;
calculating maximum consumption amounts of the plurality of next-level materials with respect to at least one of the one or more materials with shortage;
determining whether there is shortage in the plurality of next-level materials according to a maximum consumption amount and an available inventory amount of a corresponding material of the plurality of next-level materials.

3. The computer-implemented method according to claim 2, wherein the data of the plurality of materials comprises information on substitution relationships among the plurality of materials, and the data of the plurality of next-level materials further comprises information on substitution relationships among the next-level materials;
before acquiring the data of the plurality of next-level materials of the one or more materials with shortage for manufacturing the one or more product components, further comprising: discriminating one or more materials with shortage in a second group from the one or more materials with shortage according to the information on the substitution relationships among the plurality of materials; wherein the one or more materials with shortage in the second group are non-substitutable materials with respect to at least one of the one or more product components;
before calculating the maximum consumption amounts of the plurality of next-level materials with respect to at least one of the one or more materials with shortage, further comprising: discriminating, data of one or more next-level materials in a third group and data of one or more next-level materials in a fourth group from data of the one or more materials with shortage in the second group according to the information on the substitution relationships among the next-level materials, wherein the one or more next-level materials in the third group are substitutable materials with respect to at least one of the one or more materials with shortage in the second group, and the one or more next-level materials in the fourth group are non-substitutable materials with respect to at least one of the one or more materials with shortage in the second group.

4. The computer-implemented method according to claim 3, wherein the calculating maximum consumption amounts of the plurality of materials with respect to at least one of the one or more product components comprises: calculating a maximum consumption amount of one or more materials in the second group with respect to the one or more product components according to data of the one or more materials in the second group;
the determining whether there is shortage in one or more materials for manufacturing the one or more product components according to the maximum consumption amount of the corresponding material of the plurality of materials and the available inventory amount of the corresponding material of the plurality of materials comprises: calculating a remaining amount of the one or more materials in the second group according to an available inventory amount of the one or more materials in the second group and a maximum consumption amount of the one or more materials in the second group, and determining whether there is shortage in the one or more materials in the second group according to the remaining amount of the one or more materials in the second group.

5. The computer-implemented method according to claim 4, wherein the calculating the maximum consumption amount of the one or more materials in the second group with respect to the one or more product components according to data of the one or more materials in the second group comprises: using a sum of, a demanded amount for one or more product components requiring one or more materials in the second group as non-substitutable materials multiplied by values of corresponding unit consumption of corresponding materials in the second group with respect to manufacturing the one or more product components respectively, to obtain the maximum consumption amount of the one or more materials in the second group with respect to the one or more product components.

6. The computer-implemented method according to claim 4, wherein when it is determined that there is shortage in one or more materials in the second group, further comprising: calculating a shortage amount of the one or more materials with shortage in the second group according to the available inventory amount of the one or more materials with shortage in the second group and the maximum consumption amount of the one or more materials with shortage in the second group.

7. The computer-implemented method according to claim 6, wherein the calculating the maximum consumption amounts of the plurality of next-level materials with respect to at least one of the one or more materials with shortage comprises: calculating a maximum consumption amount of one or more next-level materials in the fourth group with respect to one or more materials with shortage in the second group;
the determining whether there is shortage in the plurality of next-level materials according to the maximum consumption amount and the available inventory amount of the corresponding material of the plurality of next-level materials comprises: using an available inventory amount of one or more next-level materials in the fourth group to subtract a maximum consumption amount of the one or more next-level materials in the fourth group to obtain a remaining amount of the one or more next-level materials in the fourth group, and determining whether there is shortage in the one or more next-level materials in the fourth group according to the remaining amount of the one or more next-level materials in the fourth group.

8. The computer-implemented method according to claim 7, wherein the calculating the maximum consumption amount of one or more next-level materials in the fourth group with respect to one or more materials with shortage in the second group comprises: using a sum of, a shortage amount of one or more materials with shortage in the second group requiring one or more next-level materials in the fourth group as non-substitutable materials multiplied by values of unit consumption of corresponding next-level materials in the fourth group for manufacturing one or more corresponding materials with shortage in the second group respectively, to obtain the maximum consumption amount of the one or more next-level materials in the fourth group with respect to the one or more materials with shortage in the second group.

9. The computer-implemented method according to claim 7, further comprising:
when it is determined that there is shortage in one or more next-level materials in the fourth group, obtaining a shortage amount of the one or more next-level materials in the fourth group according to the remaining amount of the one or more next-level materials in the fourth group, and displaying a shortage amount and a shortage state of the one or more next-level materials in the fourth group through a first output interface;
when it is determined that there is no shortage in the one or more next-level materials in the fourth group and the remaining amount is 0, displaying the remaining amount and a material state of the one or more next-level materials in the fourth group through the first output interface;
when it is determined that there is no shortage in the one or more next-level materials in the fourth group and the remaining amount is greater than 0, according to the information on the substitution relationships among the next-level materials, determining whether the one or more next-level materials in the fourth group are substitutable materials with respect to at least one of one or more materials with shortage in the first group; when it is determined that the one or more next-level materials in the fourth group are not substitutable materials with respect to the one or more materials with shortage in the first group, determining that there is overstock in the one or more next-level materials in the fourth group, and displaying an overstock state and the remaining amount of the one or more next-level materials in the fourth group through the first output interface.

10. The computer-implemented method according to claim 2, wherein the calculating the maximum consumption amounts of the plurality of next-level materials with respect to at least one of the one or more materials with shortage comprises: calculating a maximum consumption amount of one or more semi-finished components in a third group with respect to one or more materials with shortage in a second group using a third linear programming model;
the determining whether there is shortage in the plurality of next-level materials according to the maximum consumption amount and the available inventory amount of the corresponding material of the plurality of next-level materials comprises: using an available inventory amount of one or more next-level materials in the third group to subtract a maximum consumption amount of the one or more next-level materials in the third group to obtain a remaining amount of the one or more next-level materials in the third group, and determining whether there is shortage in the one or more next-level materials in the third group according to the remaining amount of the one or more next-level materials in the third group.

11. The computer-implemented method according to claim 10, further comprising:
when it is determined that there is shortage in the one or more next-level materials in the third group, obtaining a shortage amount of the one or more next-level materials in the third group according to the remaining amount of the one or more next-level materials in the third group, and displaying the shortage amount and a shortage state of the one or more next-level materials in the third group through a first output interface;
when it is determined that there is no shortage in the one or more next-level materials in the third group and the remaining amount is 0, displaying the remaining amount and a material state of the one or more next-level materials in the third group through the first output interface;
when it is determined that there is no shortage in the one or more next-level materials in the third group and the remaining amount is greater than 0, according to the information on the substitution relationships among the next-level materials, determining whether the one or more next-level materials in the third group are substitutable materials with respect to at least one of one or more materials with shortage in the first group; when it is determined that one or more materials in the third group are not substitutable materials with respect to the one or more materials with shortage in the first group, determining that there is overstock in the one or more next-level materials in the third group, and displaying an overstock state and the remaining amount of the one or more next-level materials in the third group through the first output interface.

12. The computer-implemented method according to claim 10, wherein a third objective function of the third linear programming model is expressed as follows:
$$obj 3 = max {\sum }_{i = 1}^{N} {d}_{i} * {x}_{i} ;$$
herein, xᵢ represents a satisfiable amount of a corresponding next-level material in the third group for preparation of a corresponding material with shortage in the second group; dᵢ represents a value of unit consumption of a corresponding next-level material in the third group with respect to one or more corresponding materials with shortage in the second group; N is a positive integer, N≥1.

13-14. (canceled)

15. The computer-implemented method according to claim 2, wherein the data of the plurality of materials comprises information on substitution relationships among the plurality of materials and a demanded amount for one or more product components;
before acquiring the data of the plurality of next-level materials of the one or more materials with shortage for manufacturing the one or more product components, further comprising: discriminating one or more materials in a first group from the plurality of materials according to the information on the substitution relationships among the plurality of materials, wherein the one or more materials in the first group are substitutable materials with respect to at least one of the one or more product components;
the calculating the maximum consumption amounts of the plurality of materials with respect to at least one of the one or more product components comprises: calculating a maximum consumption amount of the one or more materials in the first group with respect to the one or more product components according to data of the one or more materials in the first group;
the determining whether there is shortage in one or more materials for manufacturing the one or more product components according to the maximum consumption amount of the corresponding material of the plurality of materials and the available inventory amount of the corresponding material of the plurality of materials comprises: acquiring a satisfiable amount of one or more substitutable material groups in the first group with respect to the one or more product components when a consumption amount of one or more materials in the first group with respect to the one or more product components is a maximum consumption amount, and determining whether there is shortage in the one or more substitutable material groups in the first group with respect to a corresponding product component according to the satisfiable amount of the one or more substitutable material groups in the first group with respect to the one or more product components and the demanded amount for the one or more product components.

16. The computer-implemented method according to claim 15, wherein the determining whether there is the next-level material for the material with shortage when it is determined that there is shortage in the plurality of materials for manufacturing the one or more product components comprises: determining whether there is a next-level material for a material group with shortage in the first group when it is determined that there is shortage in one or more substitutable material groups in the first group with respect to the corresponding product component;
the acquiring data of the plurality of next-level materials of one or more materials with shortage for manufacturing the one or more product components when it is determined that there is the next-level material for the material with shortage comprises: acquiring material data of one or more next-level materials of one or more material groups with shortage in the first group when it is determined that there is a next-level material for a material group with shortage in the first group;
the calculating the maximum consumption amounts of the plurality of next-level materials with respect to at least one of the one or more materials with shortage comprises: taking a plurality of next-level materials of one or more material groups with shortage in the first group as one or more next-level materials in a fifth group, calculating a maximum consumption amount of one or more next-level materials in the fifth group with respect to product components corresponding to one or more material groups with shortage in the first group according to material data of the one or more next-level materials in the fifth group;
the determining whether there is shortage in the plurality of next-level materials according to the maximum consumption amount and the available inventory amount of the corresponding material of the plurality of next-level materials comprises: calculating a remaining amount of one or more next-level materials in the fifth group according to an available inventory amount of one or more next-level materials in the fifth group and a maximum consumption amount of one or more next-level materials in the fifth group with respect to product components corresponding to one or more corresponding material groups with shortage in the first group, and determining whether there is shortage in the one or more next-level materials in the fifth group according to the remaining amount of the one or more next-level materials in the fifth group.

17-20. (canceled)

21. The computer-implemented method according to claim 2, further comprising: displaying a shortage state of a material with shortage through a first output interface when it is determined that there is no next-level material for the material with shortage;
when it is determined that there is no shortage in one or more materials for manufacturing one or more product components, displaying material information of the one or more materials for manufacturing the one or more product components through the first output interface.

22. The computer-implemented method according to claim 2, further comprising: adjusting a demand for the one or more product components to minimize overstock or shortage in the next-level materials when it is determined that there is overstock or shortage in the one or more materials with shortage according to the maximum consumption amount and the available inventory amount of the corresponding material of the plurality of next-level materials; producing the one or more product components based on an adjusted demand for the one or more product components.

23. The computer-implemented method according to claim 2, further comprising: generating one or more user interfaces;
wherein the one or more user interfaces comprise a first output interface, and the first output interface is further configured to display a material state of a corresponding material in at least one of a first group to a fifth group.

24-26. (canceled)

27. The computer-implemented method according to claim 2, further comprising:
receiving a material state query instruction input by a user through the first input interface;
in response to the material state query instruction, acquiring, from the data source, at least one of remaining amounts, overstock states, shortage states, shortage amounts of the plurality of materials for manufacturing the one or more product components and a plurality of next-level materials of the plurality of materials.

28. An apparatus for managing production of one or more products, comprising:
a memory; and
one or more processors;
wherein the memory and the one or more processors are connected with each other; computer-executable instructions for controlling the one or more processors to perform following operations are stored in the memory:
receiving a material query instruction input by a user through a first input interface;
in response to the material query instruction, acquiring, from a data source, data of a plurality of materials for manufacturing one or more product components, wherein the data of the plurality of materials comprises available inventory amounts of the plurality of materials;
calculating maximum consumption amounts of the plurality of materials with respect to at least one of the one or more product components; and
determining whether there is shortage in one or more materials for manufacturing the one or more product components according to a maximum consumption amount of a corresponding material of the plurality of materials and an available inventory amount of the corresponding material of the plurality of materials.

29. A non-transitory tangible computer-readable medium having computer-readable instructions thereon, wherein the computer-readable instructions are able to be executed by a processor to enable the processor to perform following operations:
receiving a material query instruction input by a user through a first input interface;
in response to the material query instruction, acquiring, from a data source, data of a plurality of materials for manufacturing one or more product components, wherein the data of the plurality of materials comprises available inventory amounts of the plurality of materials;
calculating maximum consumption amounts of the plurality of materials with respect to at least one of the one or more product components; and
determining whether there is shortage in one or more materials for manufacturing the one or more product components according to a maximum consumption amount of a corresponding material of the plurality of materials and an available inventory amount of the corresponding material of the plurality of materials.
